(19) United States
(12) Patent Application Publication
(10) Pub. No.: US 2014/0254660 A1
(43) Pub. Date: Sep. 11, 2014

(54) VIDEO ENCODER, METHOD OF DETECTING SCENE CHANGE AND METHOD OF CONTROLLING VIDEO ENCODER

(71) Applicant: BYEONG-DU LA, SUWON-SI (KR)

(72) Inventor: BYEONG-DU LA, SUWON-SI (KR)

(21) Appl. No.: 14/191,707

(22) Filed: Feb. 27, 2014

(30) Foreign Application Priority Data
Mar. 6, 2013 (KR) 10-2013-0023694

(51) Int. Cl. H04N 19/142; H04N 19/593; H04N 19/503

(52) U.S. Cl. CPC H04N 19/00163; H04N 19/00575; H04N 19/00763
USPC 375/240.02

(57) ABSTRACT

A video encoder is configured to encode video data in units of macroblocks based on a group of pictures (GOP), the GOP being determined by assigning intra pictures and inter pictures, each intra picture being encoded without reference to other pictures, and each inter picture being encoded with reference to other pictures. The method of controlling the video controller includes determining an encoding mode of each macroblock by performing an intra-picture prediction and an inter-picture prediction, detecting whether each unit of a picture is a scene change based on a result of the intra-picture prediction and the inter-picture prediction for determining the encoding mode of each macroblock, and adaptively setting a size of the GOP based on a result of detecting whether each unit of a picture is the scene change.

### CROSS-REFERENCE TO RELATED APPLICATION

A claim of priority under 35 USC §119 is made to Korean Patent Application No. 10-2013-0023694, filed on Mar. 6, 2013, in the Korean Intellectual Property Office (KIPO), the disclosure of which is incorporated by reference in its entirety herein.

### BACKGROUND

Example embodiments relate generally to video data compression. More particularly, example embodiments relate to a video encoder, a method of detecting a scene change, and a method of controlling a video encoder for adaptively setting a size of a group of pictures (GOP).

MPEG (Moving Picture Expert Group) under ISO/IEC (International Organization for Standardization/International Electrotechnical Commission) and VCEG (Video Coding Expert Group) under ITU-T (International Telecommunications Union Telecommunication) are leading standards of video encoding. MPEG and VCEG have organized JVT (Joint Video Team), which has finalized H.264/AVC (Advanced Video Coding), the international standard of video encoding. Compared with the former standards of video coding (such as MPEG-2, MPEG-4, H.261, H.263, etc.), H.264/AVC provides improved video data compression performance by introducing functions such as variable block size motion estimation, ¼ pixel motion vector resolution, multiple reference picture motion estimation, and others.

These additional functions increase a complexity of the encoder and a stream size of the encoded data, making it difficult to adopt H.264 in certain applications such as real-time video encoders.

As one suggested approach for enhancing compression efficiency in the encoder, a scene change may be detected through pre-processing, and the new GOP may begin based on the picture detected as a scene change. However, a complexity of the video encoder is increased and an encoding speed is reduced significantly as result of the pre-processing.

### SUMMARY

According to example embodiments, a method of controlling a video encoder is provided. The video encoder is configured to encode video data in units of macroblocks based on a group of pictures (GOP), the GOP being determined by assigning intra pictures and inter pictures, each intra picture being encoded without reference to other pictures, and each inter picture being encoded with reference to other pictures. The method includes determining an encoding mode of each macroblock by performing an intra-picture prediction and an inter-picture prediction, detecting whether each unit of a picture is a scene change based on a result of the intra-picture prediction and the inter-picture prediction for determining the encoding mode of each macroblock, and adaptively setting a size of the GOP based on a result of detecting whether each unit of a picture is the scene change.

Adaptively setting the size of the GOP may include, when the scene change is not detected, setting the size of the GOP to a normal size by regularly assigning the intra picture, and when a first picture is detected as the scene change, setting the size of the GOP including the first picture to an increased size which is greater than the normal size.

Setting the size of the GOP to the increased size may include assigning the inter picture to a second picture after the first picture where the second picture is to be assigned as the intra picture according to the normal size when the scene change is not detected.

Setting the size of the GOP to the increased size may further include, when a third picture is detected as the scene change again after assigning the inter picture to the second picture, assigning the inter picture to a fourth picture after the third picture where the fourth picture is to be assigned as the intra picture according to the normal size when the scene change is not detected. Here, a P picture may be assigned to the second picture and the fourth picture, where the P picture is encoded with reference to at least one of previous pictures.

The increased sized may be K times the normal size, where K is an integer greater than two.

Setting the size of the GOP to the increased size may include assigning the intra picture to a second picture after the first picture where a number of pictures between the first and second pictures corresponds to an additional size.

Setting the size of the GOP to the increased size may further include, when a third picture is detected as the scene change again before assigning the intra picture to the second picture, assigning the intra picture to a fourth picture after the third picture where a number of pictures between the third and fourth pictures corresponds to the additional size.

The size of the GOP including at least one picture detected as the scene change may be set to a sum of the additional size and a number of pictures between the previous intra picture and the picture lastly detected as the scene change. Also, the additional size may be set to be equal to the normal size.

Adaptively setting the size of the GOP may include, when the scene change is not detected, setting the size of the GOP to a normal size by regularly assigning the intra picture, and when a first picture is detected as the scene change and the first picture is between a previous intra picture and a K-th picture from the previous intra picture, where K is a positive integer smaller than the normal size, setting the size of the GOP including the first picture to the normal size, and when the first picture is after the K-th picture, setting the size of the GOP including the first picture to an increased size which is greater than the normal size.

Determining the encoding mode of each macroblock may include calculating a least intra rate-distortion cost by the intra-picture prediction and a least inter rate-distortion cost by the inter-picture prediction, with respect to each macroblock, and determining the encoding mode as a mode corresponding to a smaller value among the least intra rate-distortion cost and the least inter rate-distortion cost.

Detecting whether each unit of a picture is a scene change may include, with respect to a plurality of macroblocks in each picture, calculating an intra accumulation value and an inter accumulation value by summing the least intra rate-distortion costs and by summing the least inter rate-distortion costs, and determining whether the scene change is detected with respect to each picture based on the intra accumulation value and the inter accumulation value.

Determining whether the scene change is detected may include calculating a ratio of the intra accumulation value to the inter accumulation value, determining that the scene change is detected when the ratio is equal to or smaller than a reference value, and determining that the scene change is not detected when the ratio is greater than the reference value.

Detecting whether each unit of a picture is a scene change may further include generating a flag signal indicating whether the scene change is detected.

Detecting the scene change may be omitted with respect to each intra picture and detecting the scene change may be performed with respect to each inter picture.

Detecting the scene change may be omitted with respect to each intra picture and each of B pictures, and detecting the scene change may be performed with respect to each of P pictures, where each P picture is encoded with reference to at least one of previous pictures and each B picture is encoded with reference to at least one of previous pictures and at least one of next pictures.

Detecting the scene change may be omitted with respect to pictures prior a K-th picture from a previous intra picture, where K is a positive integer smaller than the normal size, and detecting the scene change may be performed with respect to the pictures after the K-th picture.

The method may further include controlling a bit rate of encoded data based on the result of the intra-picture prediction and the inter-picture prediction for determining the encoding mode of each macroblock.

Controlling the bit rate of the encoded data may include adjusting a quantization parameter in units of a macroblock based on a least intra rate-distortion cost and a least inter rate-distortion cost of each macroblock.

Controlling the bit rate of the encoded data may include adjusting a quantization parameter in units of a picture based on an intra accumulation value and an inter accumulation value that are calculated by summing least intra rate-distortion costs and least inter rate-distortion costs of a plurality of macroblocks in each picture.

The video encoder may be compatible with an H.264 standard.

According to example embodiments, a video encoder for encoding video data in units of a macroblock based on a group of pictures (GOP) is provided. The GOP is determined by assigning intra pictures and inter pictures, each intra picture being encoded without reference to other pictures, and each inter picture being encoded with reference to other pictures. The video encoder includes an encoding module configured to determine an encoding mode of each macroblock by performing an intra-picture prediction and an inter-picture prediction, where the video data is encoded by units of macroblocks according to the determined encoding mode, and a control module configured to detect a scene change in units of a picture based on a result of the intra-picture prediction and the inter-picture prediction for determining the encoding mode of each macroblock, and configured to adaptively set a size of the GOP based on a detection result of the scene change.

The control module may include a scene change detection block configured to generate a flag signal indicating whether the scene change is detected based on an intra accumulation value and an inter accumulation value where the intra accumulation value and the inter accumulation value are calculated by summing least intra ratio-distortion costs and least inter ratio-distortion costs in units of a picture, and the least intra ratio-distortion costs and least inter ratio-distortion costs are provided from the encoding module in units of a macroblock. The control module may further include a picture type decision block configured to set the size of the GOP based on the flag signal.

The video encoder may further include a bit rate control block configured to control a bit rate of encoded data based on the result of the intra-picture prediction and the inter-picture prediction for determining the encoding mode of each macroblock.

The bit rate control block may be configured to adjust a quantization parameter in units of a macroblock based on a least intra rate-distortion cost and a least inter rate-distortion cost of each macroblock.

The bit rate control block may be configured to adjust a quantization parameter in units of a picture based on an intra accumulation value and an inter accumulation value that are calculated by summing least intra rate-distortion costs and least inter rate-distortion costs of a plurality of macroblocks in each picture.

The video encoder may be included in a processor of a computing system, where the computing system also includes an image sensor. Also, the video encoder may be compatible with an H.264 standard.

According to example embodiments, a method of detecting a scene change in video data is provided which includes receiving video data, calculating a least intra rate-distortion cost by an intra-picture prediction and a least inter rate-distortion cost by an inter-picture prediction, with respect to each macroblock of the video data, and with respect to a plurality of macroblocks in each picture of the video data, calculating an intra accumulation value and an inter accumulation value by summing the least intra rate-distortion costs and by summing the least inter rate-distortion costs. The method further includes determining whether the scene change is detected with respect to each picture based on the intra accumulation value and the inter accumulation value.

### BRIEF DESCRIPTION OF THE DRAWINGS

Example embodiments of the inventive concept will be more clearly understood from the detailed description that follows taken in conjunction with the accompanying drawings.

FIG. 1 is a flow chart for reference in describing a method of controlling a video encoder according to example embodiments of the inventive concept.

FIG. 2 is a block diagram illustrating a video encoder according to example embodiments of the inventive concept.

FIG. 3 is a diagram illustrating an example of groups of pictures (GOPs) that are set regularly.

FIG. 4 is a flow chart for reference in describing a method of setting GOPs adaptively according to an example embodiment of the inventive concept.

FIGS. 5, 6 and 7 are diagrams illustrating examples of GOPs that are adaptively set according to example embodiments of the inventive concept.

FIG. 8 is a block diagram illustrating an example of a picture type decision block in the video encoder of FIG. 2.

FIG. 9 is a diagram for reference in describing an operational example of the picture type decision block of FIG. 8.

FIG. 10 is a diagram illustrating an example of bit numbers of pictures according to a regular GOP setting.

FIGS. 11, 12 and 13 are diagrams illustrating examples of some of pictures in FIG. 10.

FIG. 14 is a diagram illustrating an example of bit numbers of pictures according to an adaptive GOP setting.

FIG. 15 is a diagram illustrating an example of one of pictures in FIG. 14.

FIG. 16 is a diagram illustrating adaptive and regular GOP setting examples of a signal-to-noise ratio relative to a bit rate.

FIGS. 17 and 18 are diagrams illustrating examples of GOPs that are adaptively set according to example embodiments of the inventive concept.

FIG. 19 is a flow chart for reference in describing a method of setting GOPs adaptively according to an example embodiment of the inventive concept.

FIG. 20 is a diagram illustrating an example of GOPs that are adaptively set according to an example embodiment of the inventive concept.

FIG. 21 is a block diagram illustrating an example of a picture type decision block in the video encoder of FIG. 2.

FIG. 22 is a diagram illustrating an operation of the picture type decision block of FIG. 21.

FIG. 23 is a diagram illustrating an example of GOPs that are adaptively set according to an example embodiment of the inventive concept.

FIG. 24 is a flow chart for reference in describing a method of operating a video encoder according to example embodiments.

FIG. 25 is a flow chart for reference in describing a method of detecting a scene change according to example embodiments.

FIG. 26 is a block diagram illustrating an example of a scene change detection block in the video encoder of FIG. 2.

FIG. 27 is a block diagram illustrating an example of an enable signal generator in the video encoder of FIG. 2.

FIG. 28 is a flow chart for reference in describing a method of operating a video encoder according to example embodiments.

FIG. 29 is a diagram for describing examples of reference pictures depending on picture types.

FIGS. 30, 31 and 32 are diagrams for describing relationship examples between detected scene changes and real scene changes.

FIG. 33 is a block diagram illustrating a video encoder according to example embodiments of the inventive concept.

FIG. 34 illustrates a block diagram of a computer system including a video encoder according to example embodiments of the inventive concept.

FIG. 35 illustrates a block diagram of an interface employable in the computing system of FIG. 34 according to example embodiments of the inventive concept.

### DETAILED DESCRIPTION OF THE EMBODIMENTS

Various example embodiments will be described more fully hereinafter with reference to the accompanying drawings, in which some example embodiments are shown. The present inventive concept may, however, be embodied in many different forms and should not be construed as limited to the example embodiments set forth herein. Rather, these example embodiments are provided so that this disclosure will be thorough and complete, and will fully convey the scope of the present inventive concept to those skilled in the art. In the drawings, the sizes and relative sizes of layers and regions may be exaggerated for clarity. Like numerals refer to like elements throughout.

It will be understood that, although the terms first, second, third etc. may be used herein to describe various elements, these elements should not be limited by these terms. These terms are used to distinguish one element from another. Thus, a first element discussed below could be termed a second element without departing from the teachings of the present inventive concept. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular example embodiments only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

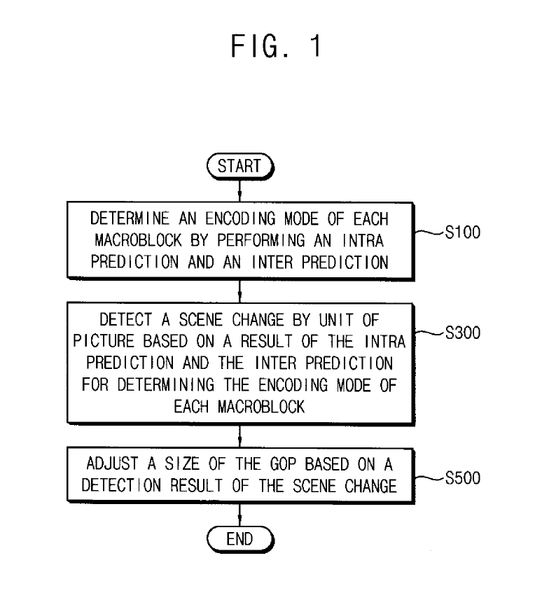

FIG. 1 is a flow chart for reference in describing a method of controlling a video encoder according to example embodiments of the inventive concept.

In this example embodiment, the video encoder is configured to encode video data in units of a macroblock based on a group of pictures (GOP). The GOP is determined by assigning intra pictures and inter pictures, where each intra picture is encoded without reference to other pictures (i.e., coded independently of other pictures) and each inter picture is encoded with reference to other pictures (i.e., coded dependently of other pictures).

Referring to FIG. 1, an encoding mode of each macroblock is determined by performing an intra-picture (e.g., intra-frame, intra-field, etc.) prediction and an inter-picture (e.g., inter-frame, inter-field, etc.) prediction (S100). The video data may be encoded by unit of a picture according to standards such as MPEG, H.261, H.262, H.263, H.264, etc. The picture may correspond to a frame in progressive scan form or a field in an interlaced scan form. The encoded picture is restored later by a decoder and the restored picture is stored in a memory such as a decoded picture buffer (DPB). The stored picture may be used as a reference picture of motion estimation when decoding a next picture. In general, one picture may be divided into macroblocks such that each macroblock includes 16*16 pixels, so that each picture may be encoded and decoded in units of a macroblock. A picture type may be determined with respect to each of encoded pictures and the intra-picture prediction and the inter-picture prediction may be performed for each of the macroblocks, which are input sequentially to the encoder, according to the picture type. When the encoded picture is determined as the intra picture, only the intra-picture prediction may be performed for each of macroblocks in the intra picture. When the encoded picture is determined as the inter picture, both of the intra-picture prediction and the inter-picture prediction may be performed for each of macroblocks in the inter picture. Herein, the intra picture may be referred to as the I picture, and the inter picture may be referred to as the P picture (predictive picture) and/or the B picture (bi-directional predictive picture).

A scene change is detected in units of a picture based on a result of the intra-picture prediction and the inter-picture prediction for determining the encoding mode of each macroblock (S300). From the view points of image quality and stream size (or a bit rate) of the encoded data, it is most efficient to detect the scene change through pre-processing before encoding the picture and set a new GOP by assigning the intra picture to the picture detected as the scene change. In the case of such pre-processing, however, the complexity of the video encoder is increased and the encoding speed is reduced significantly due to the pre-processing. According to example embodiments of the inventive concept, the detection of the scene change may be performed through post-processing. In other words, the detection of the scene change may be performed using the prediction result that is inevitably required in the encoding process.

A size of the GOP is adjusted based on a detection result of the scene change (S500). The adjustment of the GOP size is applied to pictures after the picture detected as the scene change because the scene change detection is performed through the post-processing.

As such, by detecting the scene change through the post-processing and adaptively adjusting the GOP size based on the detection result of the scene change, the bit rate of the encoded data may be efficiently reduced without excessively increasing the complexity of the video encoder.

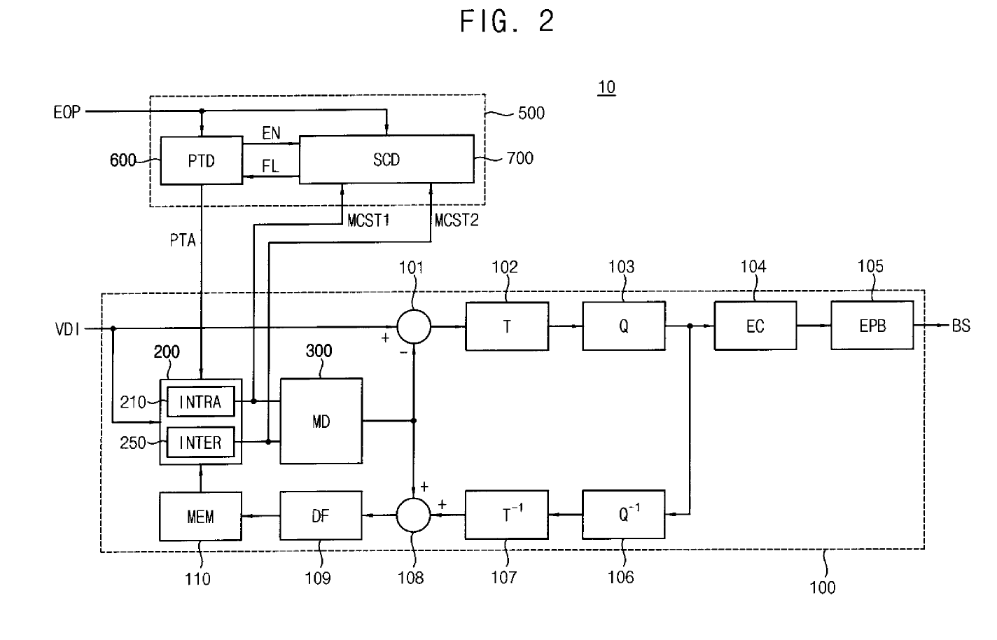

FIG. 2 is a block diagram illustrating a video encoder according to example embodiments of the inventive concept.

FIG. 2 illustrates a video encoder 10 that is configured to encode video data by a unit of a macroblock based on a group of pictures (GOP). The GOP is determined by assigning intra pictures and inter pictures, where each intra picture is encoded without reference to other pictures and each inter picture is encoded with reference to other pictures.

Referring to FIG. 2, the video encoder 10 includes an encoding module 100 and a control module 500.

The encoding module 100 receives input video data signal VDI that provides data bits in units of a macroblock. The encoding module 100 determines an encoding mode of each macroblock by performing an intra-picture prediction and an inter-picture prediction and encodes the video data in units of a macroblock according to the determined encoding mode.

The encoding module 100 may include a prediction block 200, a mode decision block (MD) 300, a subtractor 101, a transform block (T) 102, a quantization block (Q) 103, an entropy coder (EC) 104, an encoded picture buffer (EPB) 105, an inverse quantization block (Q⁻¹) 106, an inverse transform block (T⁻¹) 107, an adder 108, a deblocking filter (DF) 109 and a memory (MEM) 110.

The prediction block 200 may include an intra-picture prediction block 210 performing the intra-picture prediction and an inter-picture prediction block 250 performing the inter-picture prediction, with respect to the video data that are input in units of a macroblock. The prediction block 200 may perform the intra-picture prediction and/or the inter-picture prediction according to the picture type indicating the I picture, the P picture or the B picture, which may be determined by a picture type assigning signal PTA. When the picture type assigning signal PTA indicates that the currently encoded picture is the I picture, the inter-picture prediction block 250 may be disabled and only the intra-picture prediction block 210 may be enabled to perform the intra-picture prediction. When the picture type assigning signal PTA indicates that the currently encoded picture is the P picture or the B picture, both of the intra-picture prediction block 210 and the inter-picture prediction block 250 may be enabled to perform the intra-picture prediction and the inter-picture prediction, respectively. The intra-picture prediction block 210 may perform the intra-picture prediction to determine the encoding mode of each macroblock within the current picture without referring to other pictures. The inter-picture prediction block 250 may perform the inter-picture prediction to determine the encoding mode of each macroblock with referring to the previous pictures In the case of the P picture and with referring to the previous and next pictures In the case of the B picture.

According to H.264 standard, the available encoding modes of the macroblock may be divided largely into the inter mode and the intra mode. The inter mode may include the five motion compensation modes of skip, 16*16, 8*16, 16*8 and 8*8, and the 8*8 motion compensation mode may include the three sub-modes of 8*4, 4*8 and 4*4 with respect to each 8*8 sub-block. The intra mode may include the four 16*16 intra-picture prediction modes and the nine 4*4 intra-picture prediction modes.

The prediction block 200 may perform rate-distortion optimization as follows to encode each macroblock with one of the above-mentioned available encoding modes.

The intra-picture prediction block 210 may obtain the one intra mode that yields the least value of the intra rate-distortion cost Jmode as represented in Equation 1.

Jmode=DISTmd+Kmd*Rmd Equation 1

In Equation 1, Kmd indicates a Lagrangian coefficient for mode decision, and Rmd indicates a bit number required for encoding the macroblock with the candidate intra mode. DISTmd indicates distortion between the pixels of the restored macroblock and the input macro block. The distortion function may be one of a sum of absolute difference (SAD), a sum of absolute transformed difference (SATD), a sum of squared difference (SSD), etc. The intra-picture prediction block 210 may calculate the values of Jmode with respect to each of the intra modes, and may determine the least value of Jmode as a least intra rate-distortion cost MCST1.

The inter-picture prediction block 250 may obtain an optimal motion vector with respect to each of the inter modes except the skip mode. The optimal motion vector corresponds to a motion vector that yields the least value of the inter rate-distortion cost Jmotion as represented in Equation 2.

Jmotion=DISTmt+Kmt*Rmt Equation 2

In Equation 2, Kmt indicates a Lagrangian coefficient for motion estimation, and Rmt indicates a bit number required for encoding the macroblock using the candidate inter mode, the candidate reference picture and the candidate motion vector. DISTmt indicates distortion between the pixels of the motion-compensated macroblock by the candidate motion vector and the input macro block. The distortion function may be one of the SAD, the SATD, the SSD, etc.

The kind of the candidate motion vector may be determined depending on the magnitude of the search window. In case that the video encoder 10 refers to a plurality of reference pictures, the calculation of Equation 2 may be repeated with respect to each of the reference pictures. The inter-picture prediction block 250 may calculate the values of Jmotion with respect to each of the intra modes, each of the reference pictures and each of the candidate motion vectors and may determine the least value of Jmotion as a least inter rate-distortion cost MCST2.

The mode decision block 300 may compare the least intra rate-distortion ratio MCST1 and the least inter rate-distortion cost MCST2, and may determine the encoding mode corresponding to the smaller one of the costs MCST1 and MCST2. The mode decision block 300 may provide the determined encoding mode, the corresponding reference block, the optimal motion vector, etc.

The subtractor 101 may generate a residual block by subtracting the reference block, which is provided by the mode decision block 300, from the input macroblock. The transform block 102 may perform spatial transform with respect to the residual block generated by the subtractor 101. The spatial transform may be one of discrete cosine transform (DCT), wavelet transform, etc. The transform coefficients such as DCT coefficients, the wavelet coefficients, etc. may be obtained as the result of the spatial transform.

The quantization block may quantize the transform coefficients obtained by the transform block 102. Through the quantization such as scalar quantization, vector quantization, etc., the transform coefficients may be grouped into the discrete values. For example, according to the scalar quantization, each transform coefficient may be divided by the corresponding value in the quantization table and the quotient may be rounded off to the integer.

In the case of adopting the wavelet transform, the embedded quantization such as embedded zerotrees wavelet algorithm (EZW), set partitioning in hierarchical trees (SPIHT), embedded zeroblock coding (EZBC), etc. may be used. Such encoding process before entropy coding may be referred to as a loss encoding process.

The entropy coder 104 may perform a lossless encoding with respect to the quantized data from the quantization block 104, information of the intra-picture prediction mode, the reference picture number, the motion vector, etc. to generate a bit stream BS. The lossless encoding may be arithmetic coding such as context-adaptive binary arithmetic coding (CABAC), variable length coding such as context-adaptive variable-length coding (CAVLC), etc. The bit stream BS may be buffered in the buffer 105 and then output to an external device.

The encoded picture buffer 105, the inverse quantization block 106, and the inverse transform block 107 may be used to generate a reconstructed block by reversely decoding the lossless-encoded data.

The adder 108 may restore the input macroblock by summing the reconstructed block from the inverse transform block 107 and the reference block from the mode decision block 300. The restored macroblock may be provided to the deblocking filter 109, and the deblocking filter 109 may perform the deblock filtering with respect to the boundary of the macroblock. The filtered data are stored in the memory 110 and used as the reference picture for encoding the other pictures.

The control module 500 detects the scene change in units of a picture based on the result of the intra-picture prediction and the inter-picture prediction, that is, the least intra rate-distortion cost MCST1 and the least inter rate-distortion cost MCST2 from the encoding module 100, and adjusts the size of the GOP based on the detection result of the scene change.

The control module 500 may include a picture type decision block (PTD) 600 and a scene change detection block (SCD) 700.

The scene change detection block 700 may generate a flag signal FL indicating whether the scene change is detected based on the least intra rate-distortion cost MCST1 and the least inter rate-distortion cost MCST2 from the encoding module 100. For example, the scene change detection block 700 may calculate an intra accumulation value ACC1 and an inter accumulation value ACC2 by summing the least intra ratio-distortion costs MCST1s and the least inter ratio-distortion costs MCST2s in units of a picture to generate the flag signal FL based on the intra accumulation value ACC1 and the inter accumulation value ACC2. The scene change detection block 700 may determine the logic level of the flag signal FL in synchronization with a picture end signal EOP that is activated whenever encoding of each picture is completed.

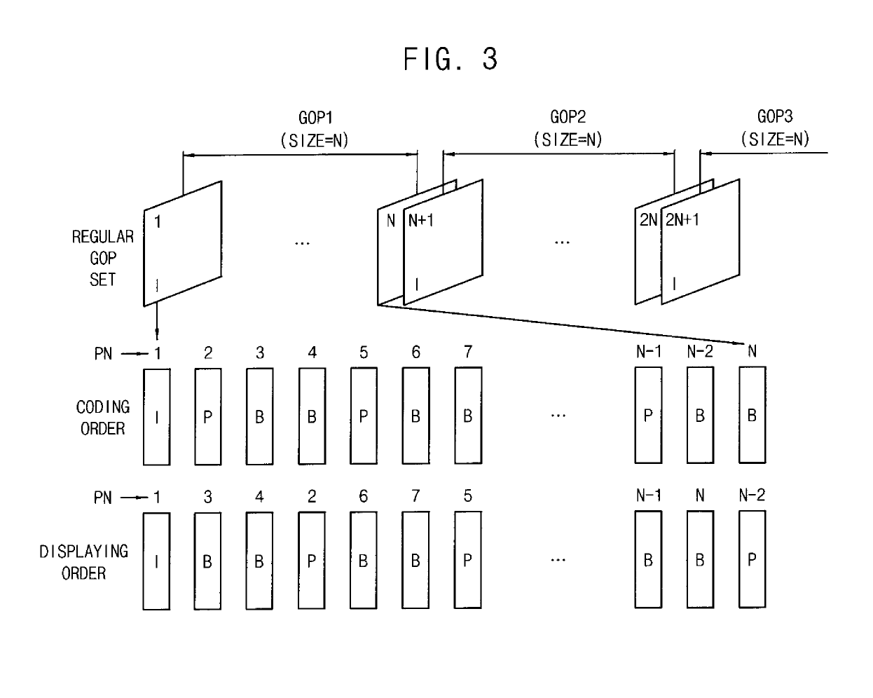

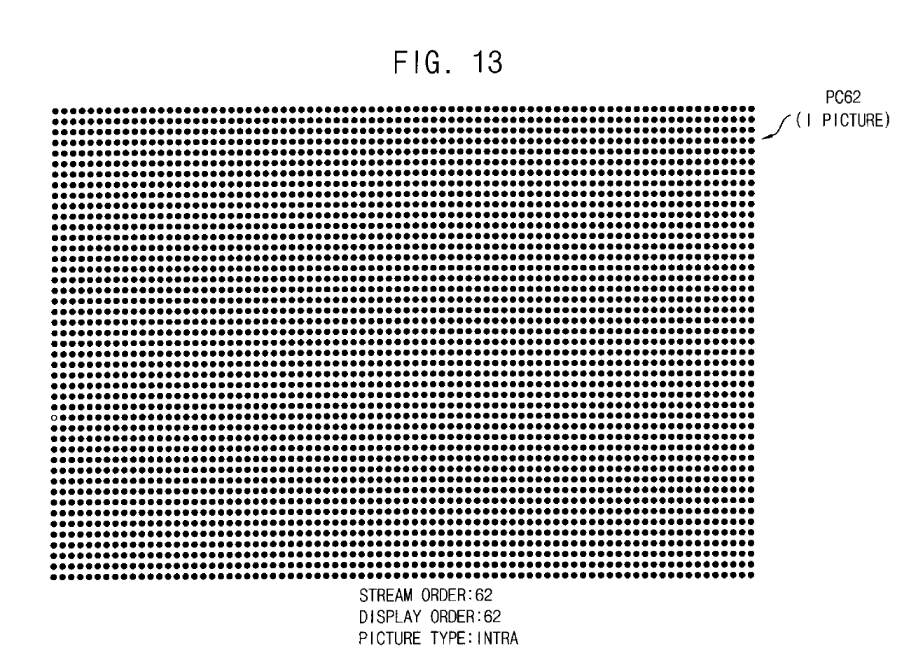

The picture type decision block 600 may adjust the size of the GOP based on the flag signal FL. The picture type decision block 600 may generate the picture type assigning signal PTA that is varied in synchronization with the picture end signal EOP to indicate the picture type of the currently-encoded picture. For example, the picture type assigning signal PTA may indicate the I picture, the P picture or the B picture. The size of the GOP may be determined by the assigning interval of the I pictures that are encoded without reference to other pictures. The structure of the GOP may be determined by the assigning pattern of the P pictures that are encoded with reference to the previous pictures and the B pictures that are encoded with reference to the next pictures. The picture type decision block 600 may generate an enable signal EN for selectively enabling the scene change detection block 700 depending on the picture type of the currently-encoded picture. Hereinafter, the configuration and the operation of the picture type decision block are described with reference to FIGS. 3 through 23.

FIG. 3 is a diagram illustrating an example of GOPs that are set regularly.

The size of the GOP may be determined by the interval of the assigned I pictures, and the structure of the GOP may be determined by the arrangement of the assigned P and/or B pictures. The bit number of the encoded data may be reduced by proper arrangement of the P and/or B pictures, that is, the inter pictures that are encoded with reference to other pictures, and error propagation through the successive inter pictures may be prevented by limiting the size of the GOP, that is, by regularly or irregularly assigning the I pictures that are encoded without reference to other pictures.

FIG. 3 illustrates an example of GOP setting with a normal size N by regularly assigning the I pictures. The picture number PN in FIG. 3 represent a coding order, and the coding order may be different from a display order depending on the structure of the GOP. A first picture assigned as the I picture to an N-th picture form a first picture group GOP1, and an N+1-th picture assigned as the next I picture to a 2N-th picture form a second picture group GOP2. In the same way, N pictures from a 2N+1-th picture form a third picture group GOP3.

The structure of the GOP may be variously determined according to the picture type assigning signal PTA generated by the picture type decision block 600 in FIG. 2. FIG. 3 illustrates an example GOP of the IPBB pattern. In this case, the display order is different from the coding order because the reference pictures are varied depending on the picture type. For example, the second picture of the P type has to be encoded before the third and fourth pictures of the B type, and then the third and fourth pictures may be encoded with reference to the encoded second picture.

According to example embodiments, the regular GOP setting as illustrated in FIG. 3 may be adopted when the scene change detection is disabled or when the scene change is not detected.

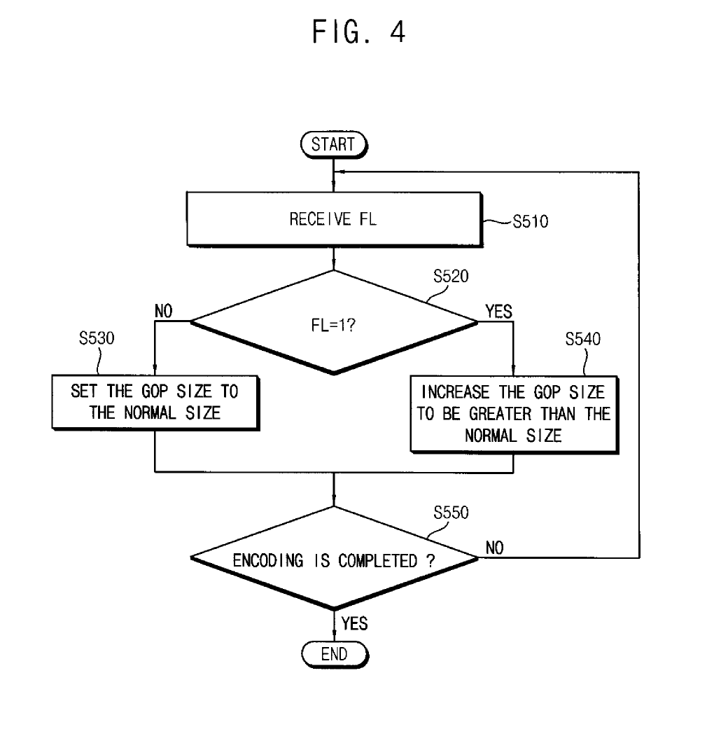

FIG. 4 is a flow chart for reference in describing a method of adaptively setting GOPs according to an example embodiment of the inventive concept.

Referring to FIGS. 2 and 4, the picture type decision block 600 may receive the flag signal FL from the scene change detection block 700 (S510). For example, the flag signal FL may have a logic high level “1” when the scene change is detected and a logic low level “0” when the scene change is not detected.

When the scene change is not detected (S520: NO), the picture type decision block 600 may set the size of the GOP to the normal size (S530) by assigning the intra picture regularly as described with reference to FIG. 3. When the scene change is detected (S520: YES), the picture type decision block 600 may increase the size of the GOP including the scene change to be greater than the normal size (S540). The logic level of the flag signal FL may be determined in units of a picture, and the above processes 5510, 5520, 5530 and 5540 are repeated in units of a picture until encoding is completed (S550: YES) with respect to all the pictures.

As such, the fluctuation in image quality and the stream size of the encoded data may be reduced by adaptively adjusting the GOP size depending on the detection of the scene change.

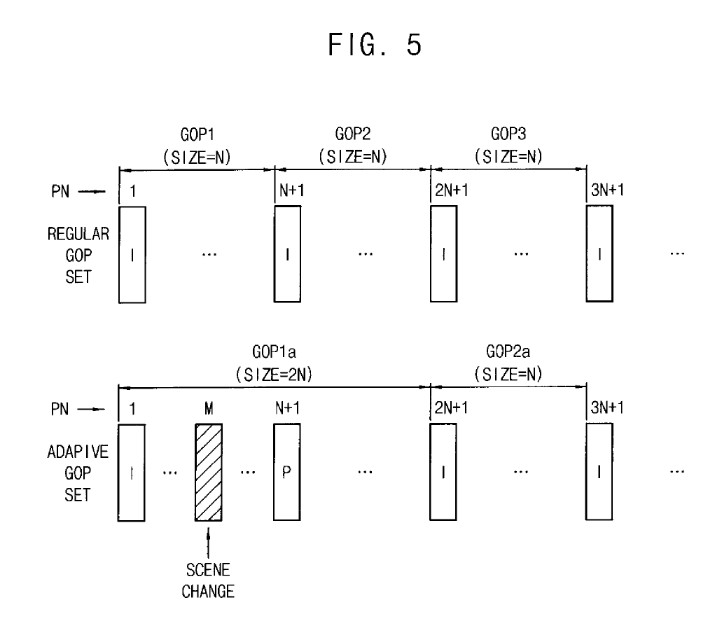

FIGS. 5, 6 and 7 are diagrams illustrating examples of GOPs that are adaptively set according to example embodiments of the inventive concept.

The regular GOP set is illustrated in the upper portions of FIGS. 5, 6 and 7, and the adaptive GOP sets when the scene change is detected are illustrated in the lower portions of FIGS. 5, 6 and 7, respectively.

As described with reference to FIG. 3, the size of the picture groups GOP1, GOP2 and GOP3 may be set to the normal size N by assigning the I picture regularly when the scene change is not detected.

Referring to FIG. 5, when the scene change is detected, the size of the picture group GOP1a including the scene change picture (M) may be increased to be greater than the normal size N. The increase of the GOP size may be implemented by substituting the picture (N+1) to be assigned as the intra picture according to the normal size N with the inter picture. In an example embodiment as illustrated in FIG. 5, the picture (N+1), which is to be assigned as the intra picture according to the normal size N if the scene change is not detected, may be assigned as the P picture. In this case, the size of the picture group GOP1a including the scene change picture (M) may be increased two times 2N the normal size N. The next picture group GOP2a may have the normal size N according to the regular GOT setting because it does not include a scene change picture.

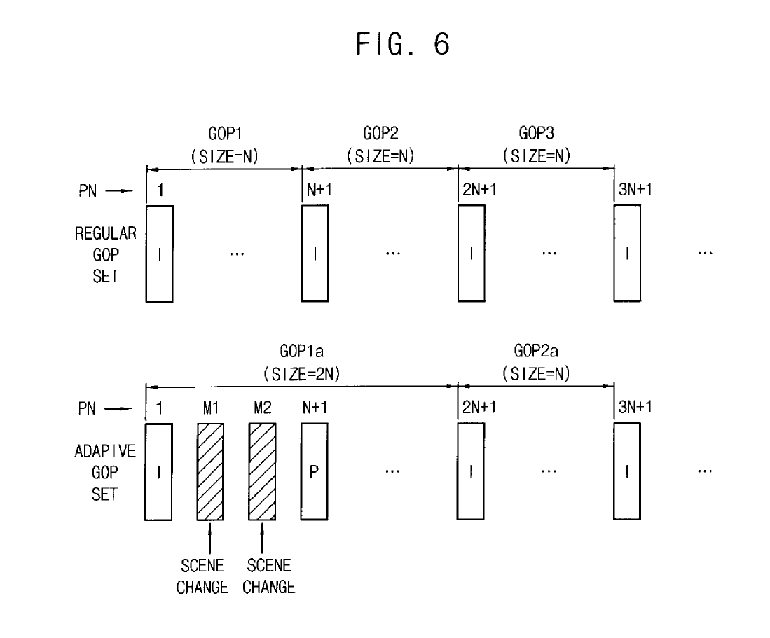

FIG. 6 illustrates an example case in which the two pictures (M1 and M2) within the normal size N are detected as the scene change. In this case, the picture (N+1) after the final scene change picture (M2), which is to be assigned as the I picture according to the normal size, may be substituted with the inter picture, e.g., the P picture. As the case of FIG. 5, the size of the picture group GOP1 a including the two scene change pictures (M1 and M2) may be increased two times 2N the normal size N. The next picture group GOP2a may have the normal size N according to the regular GOT setting because it does not include a scene change picture.

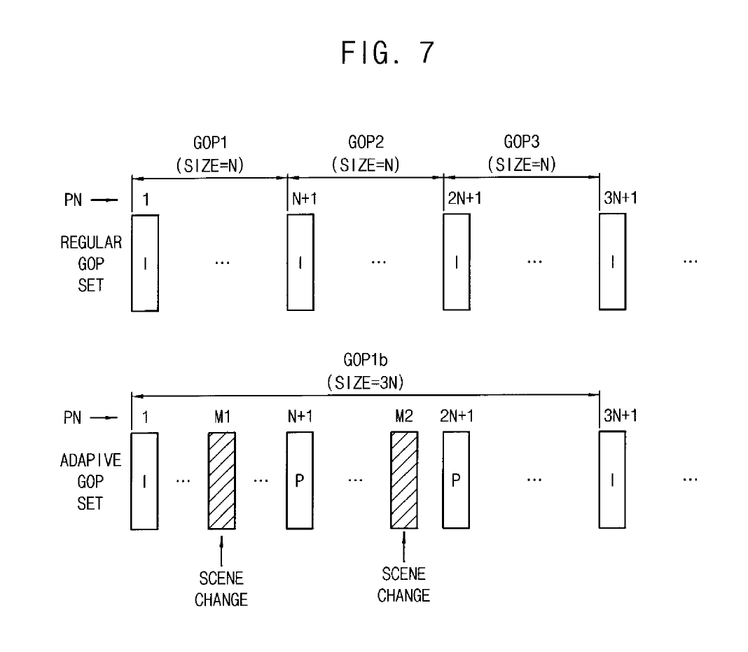

FIG. 7 illustrates an example case in which the picture (M2) is detected again as the scene change after substituting the picture (N+1) with the P picture due to the scene change picture (M1) and before assigning the next I picture to the picture (2N+1). In this case, the picture (2N+1) after the final scene change picture (M2), which is to be assigned as the I picture according to the normal size, may be substituted with the P picture again. As a result, the two pictures (N+1 and 2N+1), which are to be assigned as the I picture, may be assigned as the P picture instead of the I picture as illustrated in FIG. 7. In this case, the size of the picture group GOP1b including the two scene change pictures (M1 and M2) may be increased three times 3N the normal size N.

FIGS. 5, 6 and 7 shows example cases in which the GOP size is increased two or three times the normal size N. In this way, the size of the GOP including at least one picture detected as the scene change may be increased K times the normal size (where K is an integer greater than two).

As such, by substituting the intra picture with the inter picture based on the detection of the scene change, frequent assignment of the I picture may be avoided, thereby reducing the stream size of the encoded data and fluctuation in image quality.

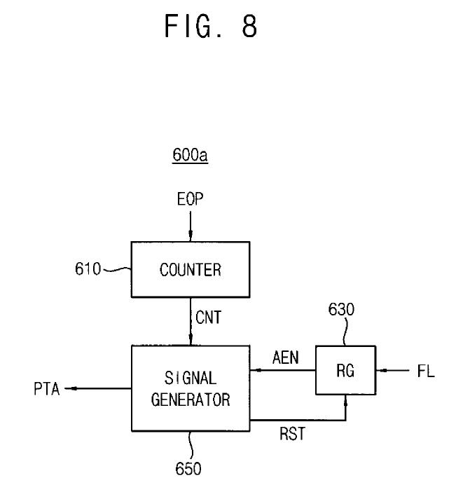

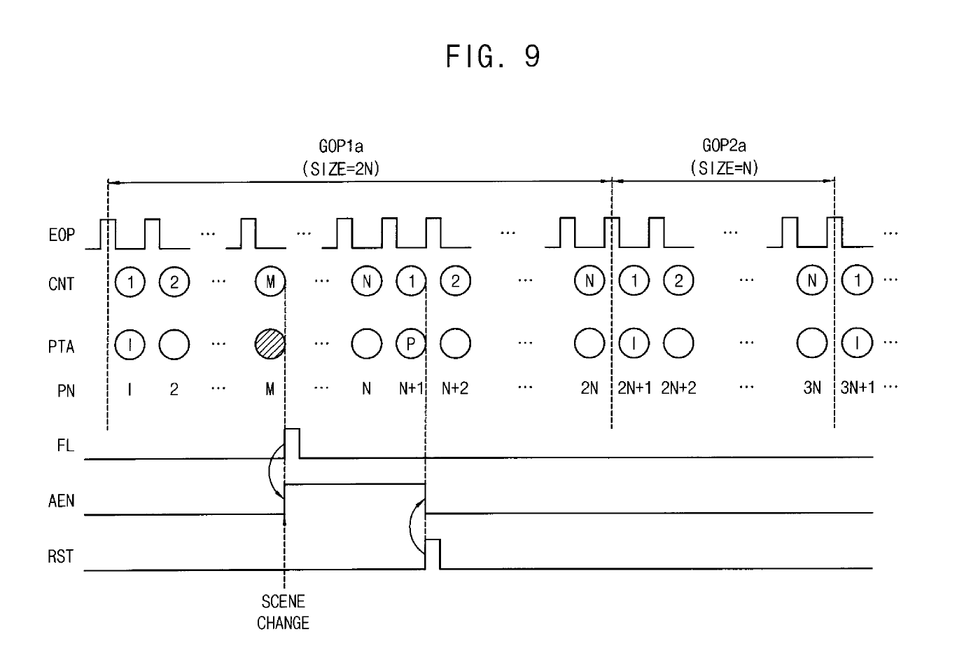

FIG. 8 is a block diagram illustrating an example of a picture type decision block in the video encoder of FIG. 2, and FIG. 9 is a diagram illustrating an operation of the picture type decision block of FIG. 8.

Referring to FIG. 8, a picture type decision block 600a may include a counter 610, a register (FG) 630 and a signal generator 650.

Referring to FIGS. 8 and 9, the counter 610 may count the normal size N to provide the counter value CNT from one to N repeatedly, in synchronization with the picture end signal EOP that is activated whenever encoding of each picture is completed. The register 630 may store the value “1” in response to the flag signal FL from the scene change detection block 700 in FIG. 2, and may store the value “0” in response to a reset signal RST from the signal generator 650. The register 630 may output an enable signal AEN having a logic level corresponding to the stored value, and the enable signal AEN may be provided to the signal generator 650.

The signal generator 650 may selectively perform the regular GOP setting or the adaptive GOP setting in response to the enable signal AEN. For example, the signal generator 650 may perform the regular GOP setting when the enable signal AEN has a logic low level and the adaptive GOP setting when the enable signal AEN has a logic high level.

When the enable signal AEN indicates the regular GOP setting, the signal generator 650 may generate the picture type assigning signal PTA based on the count value CNT according to a predetermined scheme. For example, the signal generator 650 may generate the picture type assigning signal PTA to indicate the I picture when the count value corresponds to one.

When the enable signal AEN indicates the adaptive GOP setting, the signal generator 650 may generate the picture type assigning signal PTA such that the picture, which is to be assigned as the I picture according to the normal size, may be substituted with the inter picture, and then the signal generator may activate the reset signal RST to reset the register 630 to the value “0”. After the register 630 is reset, the signal generator 650 may perform the regular GOP setting until the scene change is detected again. As a result, the size of the picture group GOP2a without the scene change may be set to the normal size N and the size of the picture group GOP1a including the scene change may be increased to 2*N.

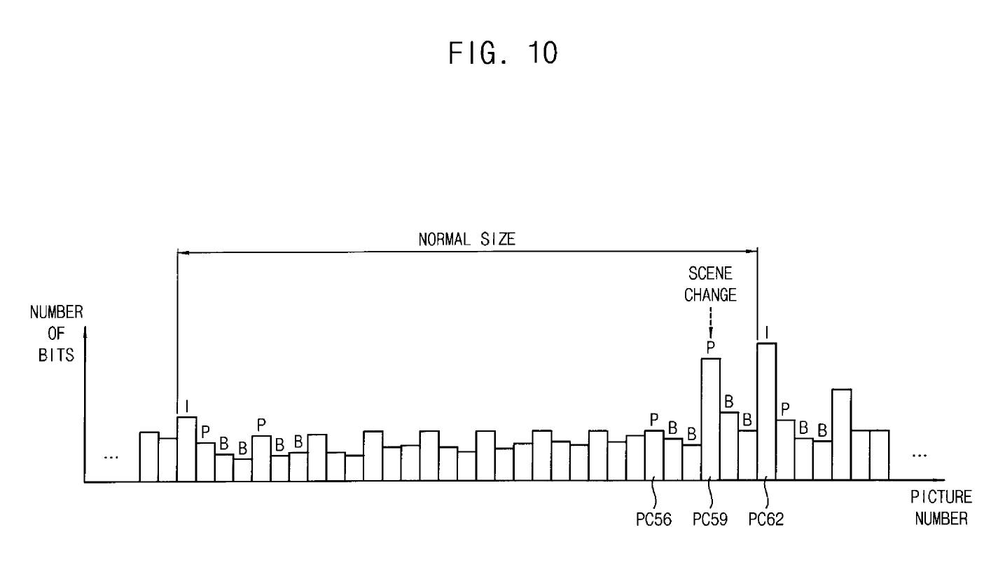

FIG. 10 is a diagram illustrating an example of bit numbers of pictures according to regular GOP setting, and FIGS. 11, 12 and 13 are diagrams illustrating examples of the pictures having bit numbers represented in FIG. 10.

The general video encoder maintains the GOP size to reduce the stream size and the fluctuation in image quality. FIG. 10 illustrates an example of the regular GOP setting associated with the general encoding. The horizontal axis represents the picture number and the vertical axis represents the bit number of each picture. The GOP in FIG. 10 has the normal size N corresponding to the number of pictures between the I pictures, and the structure in which the one P picture and the two B pictures are assigned repeatedly.

FIGS. 11, 12 and 13 illustrates the three pictures identified by reference characters in FIG. 10, that is, a first picture PC56 and a second picture PC59 that are assigned as the P pictures, and a third picture PC62 that is assigned as the I picture, respectively. The stream order, the display order and the picture type are illustrated together with the pictures PC56, PC59 and PC62. For convenience of illustration and description, the display images are omitted and the encoding modes with respect to the macroblocks are illustrated in FIGS. 11, 12 and 13. The small black circle indicates the intra mode, the small white circle indicates the inter mode, and the X character indicates the skip mode.

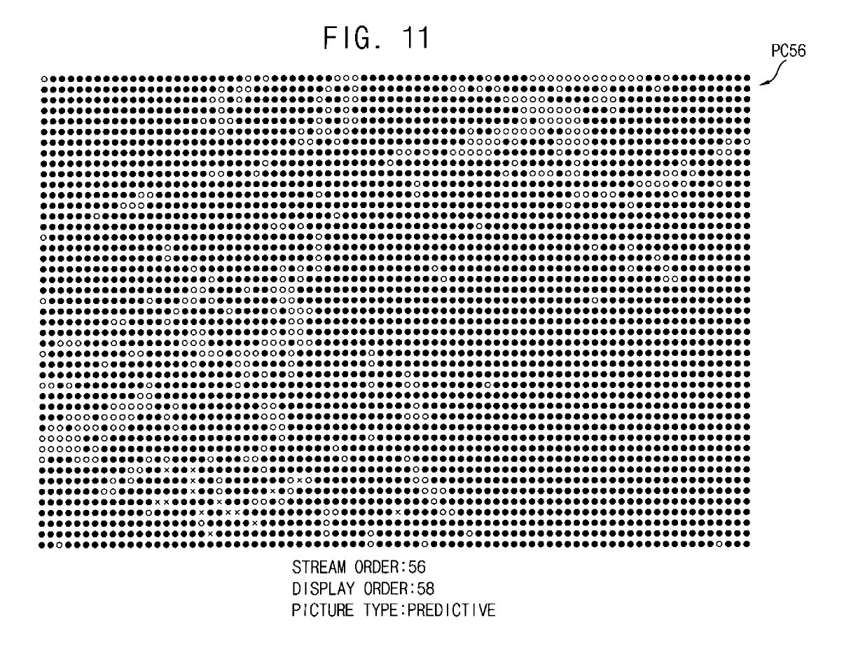

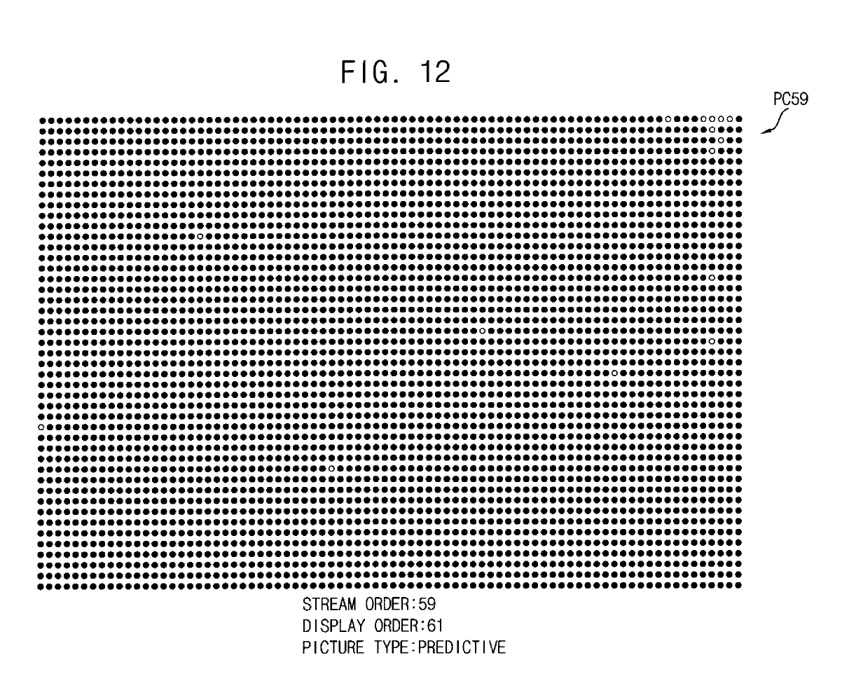

Comparing the first picture PC56 in FIG. 11 and the second picture PC59 in FIG. 12, it can be understood that the scene change occurs at the second picture PC59. Even though the second picture PC59 assigned as the P picture is encoded with reference to the previous pictures, the second picture PC59 has little correlation with the previous pictures and thus most of the macroblocks in the second picture PC59 are encoded with the intra mode. According the bit number of the second picture PC59 is increased significantly as shown in FIG. 10. According to the regular GOP setting, the third picture PC62 is assigned as the intra picture and all of the macroblocks in the third picture are encoded with the intra mode. In other words, the third pictures PC62, which is adjacent to the second picture PC59 detected as the scene change and thus encoded almost with the intra mode, is encoded with the intra mode again. As such, such mechanical application of the regular GOP setting even in the case of the scene change may unnecessarily increase the bit number of the encoded data.

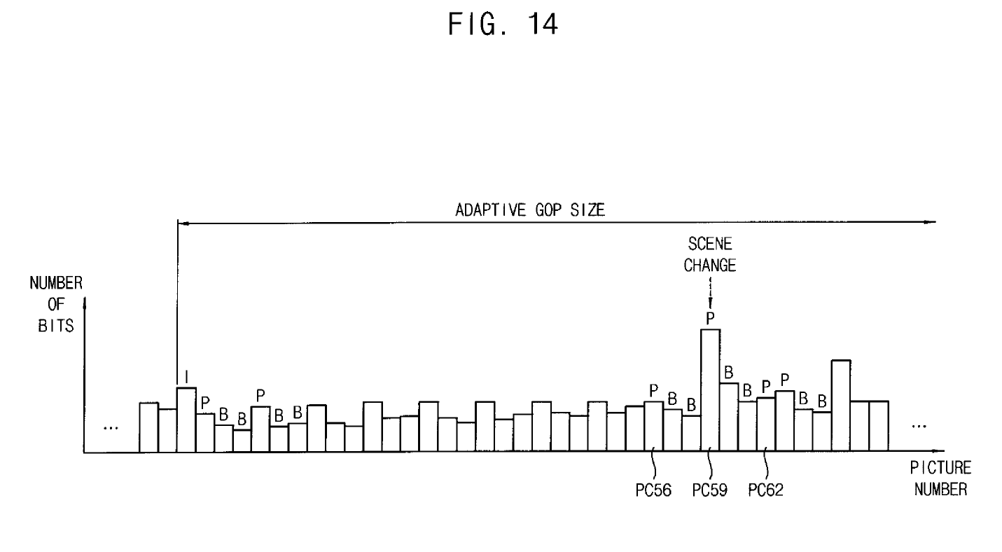

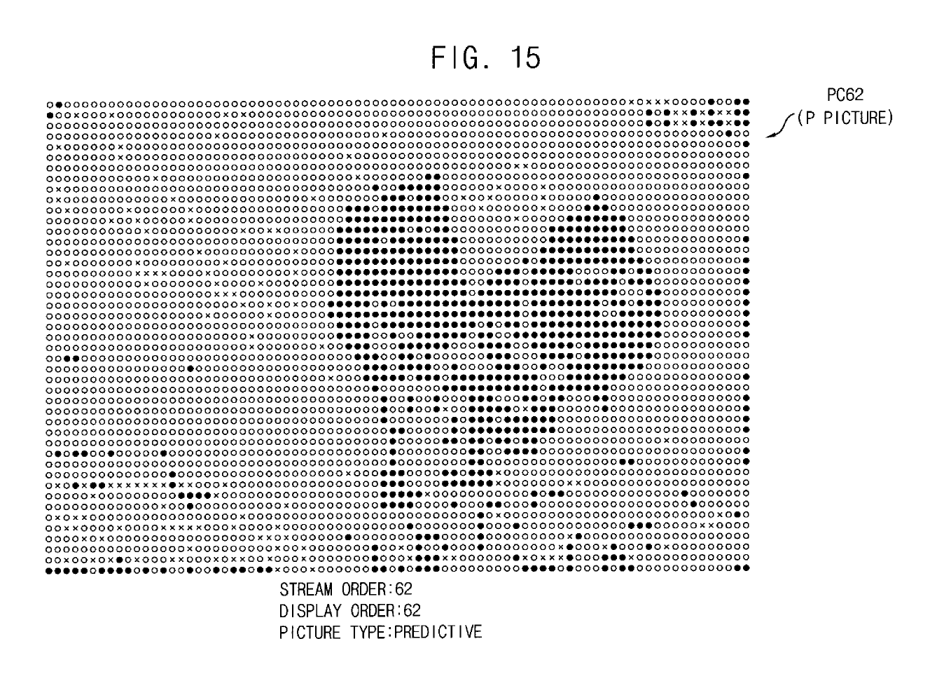

FIG. 14 is a diagram illustrating an example of bit numbers of pictures according to adaptive GOP setting, and FIG. 15 is a diagram illustrating one of the pictures in represented in FIG. 14.

Comparing FIGS. 10 and 14, the size of the GOP may be increased by substituting the third picture PC62 assigned as the I picture in FIG. 10 with the P picture in FIG. 14. FIG. 15 illustrates the third picture PC62 that is substituted with the P picture according to the adaptive GOP setting. The stream order, the display order and the picture type are illustrated together with the third picture PC62 in FIG. 15. For convenience of illustration and description, the display images are omitted and the encoding modes with respect to the macroblocks are illustrated in FIG. 15. The small black circle indicates the intra mode, the small white circle indicates the inter mode and the X character indicates the skip mode. As illustrated in FIG. 15, the most macroblocks in the third picture PC 62 substituted with the P picture are encoded with the inter mode, and thus the bit number is reduced significantly compared with the I picture PC62d in FIG. 10. Because most macroblocks in the second picture PC59 detected as the scene change are encoded with the intra mode, the image quality may be almost the same as the I picture even though the third picture PC62 is assigned as the inter picture. Rather the fluctuation of the image quality due to the frequent assignment of the I picture may be prevented by substituting the I picture after the scene change with the inter picture.

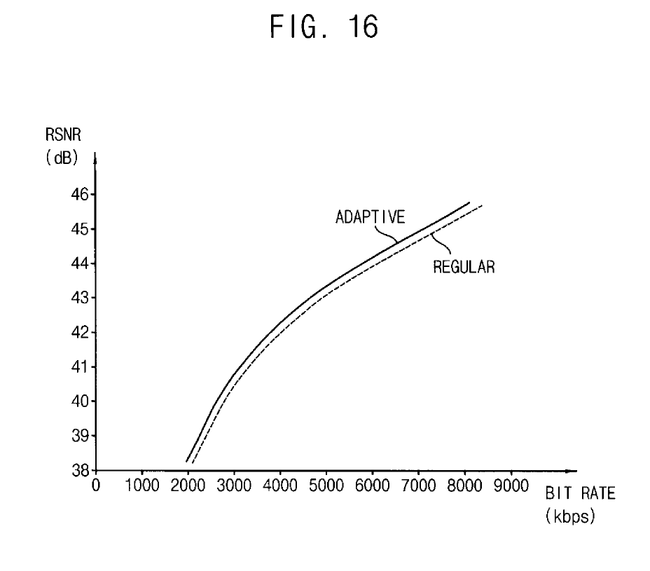

FIG. 16 is a diagram illustrating a signal-to-noise ratio depending on a bit rate.

The results of the regular GOP setting and the adaptive GOP setting are compared in FIG. 16. The vertical axis represents a peak signal-to-noise ratio (PSNR) in dB unit and the horizontal axis represents a bit rate in kbps unit.

As illustrated in FIG. 16, the PSNR may be improved by adopting the adaptive GOP setting. In other words, the same image quality or the same PSNR may be realized at the lower bit rate by adopting the adaptive GOP setting.

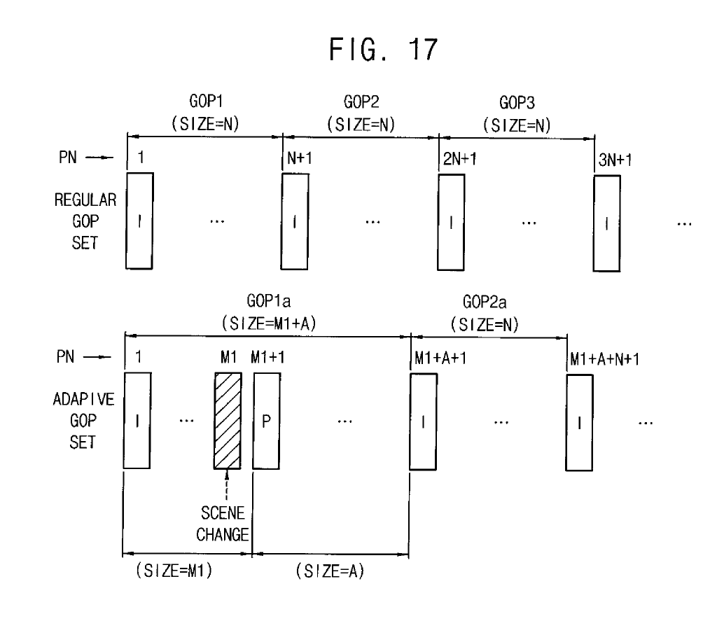

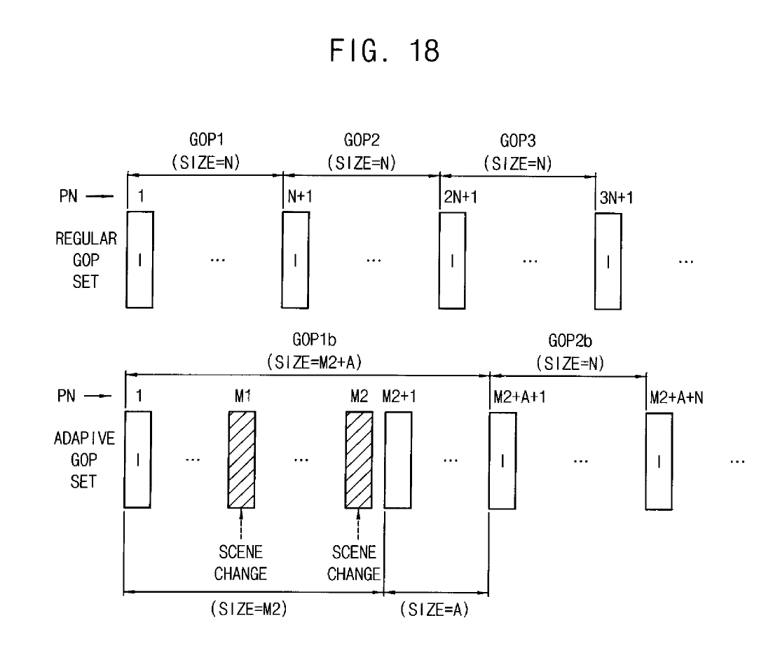

FIGS. 17 and 18 are diagrams illustrating examples of GOPs that are adaptively set according to example embodiments of the inventive concept.

The regular GOP set is illustrated in the upper portions of FIGS. 17 and 18, and the adaptive GOP sets when the scene change is detected are illustrated in the lower portions of FIGS. 17 and 18, respectively.

As described with reference to FIG. 3, the size of the picture groups GOP1, GOP2 and GOP3 may be set to the normal size N by assigning the I picture regularly when the scene change is not detected.

Referring to FIG. 17, when the scene change is detected, the size of the picture group GOP1a including the scene change picture (M) may be increased to be greater than the normal size N. The increase of the GOP size may be implemented by assigning the intra picture to the picture (M1+A+1) after the scene change picture (M1) so that the number of pictures between the scene change picture (M1) and the next intra picture (M1+A+1) may correspond to an additional size A. In this case, the size of the picture group GOP1a including the scene change picture (M1) may be increased to a sum M1+A of the additional size A and the number M1 of pictures between the previous intra picture (1) and the picture (M1) lastly detected as the scene change. The next picture group GOP2a may have the normal size N according to the regular GOT setting because it does not include the scene change picture.

FIG. 18 illustrates an example case in which the picture (M2) is detected as the scene change again before assigning the intra picture to the picture (M1+A+1) in FIG. 17. The increase of the GOP size may be implemented by assigning the intra picture to the picture (M2+A+1) after the last scene change picture (M2) so that the number of pictures between the last scene change picture (M2) and the next intra picture (M2+A+1) may correspond to the additional size A. In this case, the size of the picture group GOP1b including the scene change pictures (M1 and M2) may be increased to a sum M2+A of the additional size A and the number M2 of pictures between the previous intra picture (1) and the picture (M2) lastly detected as the scene change. The next picture group GOP2b may have the normal size N according to the regular GOT setting because it does not include the scene change picture.

As illustrated in FIGS. 17 and 18, the size of the GOP including the one more scene change pictures may be increased to the sum of the additional size A and the number M1 or M2 of pictures between the previous intra picture (1) and the picture (M1 or M2) lastly detected as the scene change. In some example embodiments, the additional size A may be set to be equal to the normal size N.

As such, by substituting the intra picture with the inter picture based on the detection of the scene change, frequent assignment of the I picture may be avoided, thereby reducing the stream size of the encoded data and fluctuation in image quality.

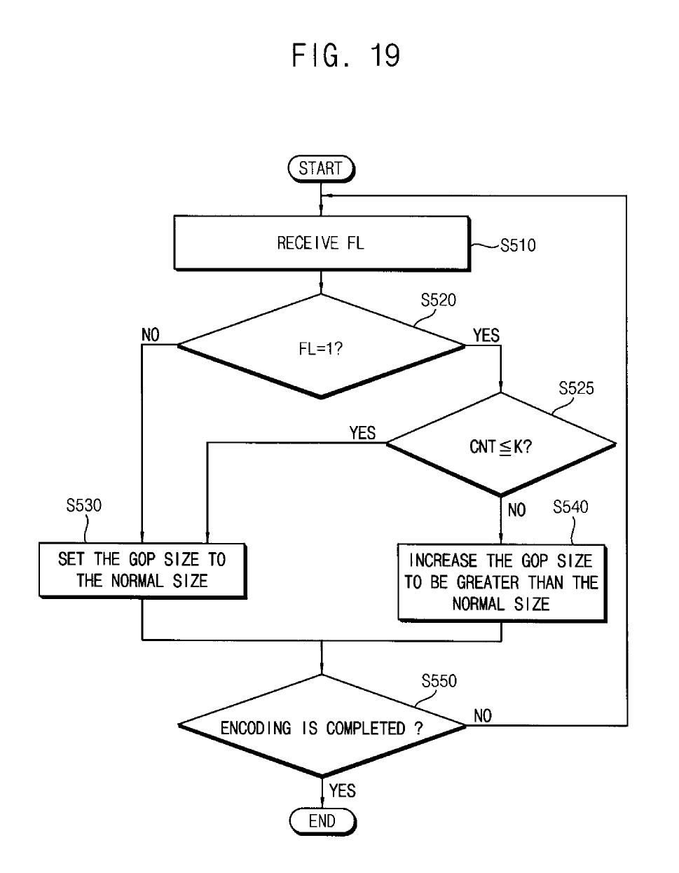

FIG. 19 is a flow chart illustrating a method of setting GOPs adaptively according to an example embodiment of the inventive concept.

Referring to FIGS. 2 and 19, the picture type decision block 600 may receive the flag signal FL from the scene change detection block 700 (S510). For example, the flag signal FL may have a logic high level “1” when the scene change is detected and a logic low level “0” when the scene change is not detected.

When the scene change is not detected (S520: NO), the picture type decision block 600 may set the size of the GOP to the normal size (S530) by assigning the intra picture regularly as described with reference to FIG. 3. When the scene change is detected (S520: YES), the picture type decision block 600 compares the count value CNT of the scene change picture with a reference value K (S525). The count value CNT may represent the location of the scene change picture in the corresponding GOP, as described with reference to FIGS. 8 and 9. When the count value CNT is equal to or smaller than the reference value K (S525: YES), the picture type decision block 600 may set the size of the GOP to the normal size (S530) by assigning the intra picture regularly. When the count value CNT is greater than the reference value K (S525: NO), the picture type decision block 600 may increase the size of the GOP including the scene change to be greater than the normal size (S540).

In other words, when the scene change picture is detected between the previous intra picture and a K-th picture from the previous intra picture where K is a positive integer smaller than the normal size, the size of the GOP including the scene change picture may be set to the normal size. The size of the GOP including the scene change picture may be increased to be greater than the normal size, only when the scene change picture is after the K-th picture.

The logic level of the flag signal FL may be determined in units of a picture, and the above processes 5510, 5520, S525, 5530 and 5540 may be repeated in units of a picture until encoding is completed (S550: YES) with respect to all the pictures.

As such, the fluctuation in image quality and the stream size of the encoded data may be reduced by adjusting the GOP size adaptively depending on the location of the scene change in the GOP in addition to the detection of the scene change.

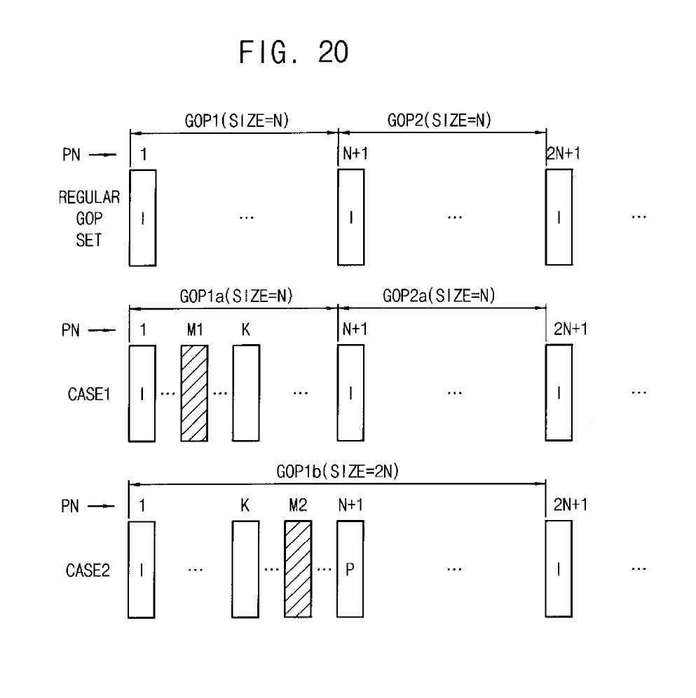

FIG. 20 is a diagram illustrating an example of GOPs that are adaptively set according to an example embodiment of the inventive concept.

The regular GOP set is illustrated in the upper portion of FIG. 20, and the adaptive GOP set when the scene change is detected is illustrated in the lower portion of FIG. 20.

As described with reference to FIG. 3, the size of the picture groups GOP1 and GOP2 may be set to the normal size N by assigning the I picture regularly when the scene change is not detected.

Referring to FIG. 20, cases of detecting the scene change may be divided into a first case CASE1 when the scene change is detected between the previous intra picture (1) and the K-th picture (K) and a second case CASE2 when the scene change is detected after the K-th picture (K). The reference value K may be properly set to be smaller than the normal size N considering the error propagation and the effect of the stream size reduction.

In the first case CASE1, the scene change occurs relatively near the previous intra picture (1) and thus the sufficient picture interval may be secured between the scene change picture (M1) and the picture (N+1) to be assigned as the intra picture according to the normal size N. In this case, the error propagation may be increased excessively if the GOP size is increased and thus the size of the picture groups GOP1a and GOP2a may be maintained as the normal size N.

In the second case CASE2, the scene change occurs relatively far from the previous intra picture (1) and thus the picture interval may be insufficient between the scene change picture (M2) and the picture (N+1) to be assigned as the intra picture according to the normal size N. In this case, the stream size may be unnecessarily increased if the normal size N is maintained. Accordingly the picture (N+1) to be assigned as the intra picture according to the normal size N may be substituted with the P picture and the picture group GOP1b including the scene change picture (M2) may be increased two time 2*N the normal size N.

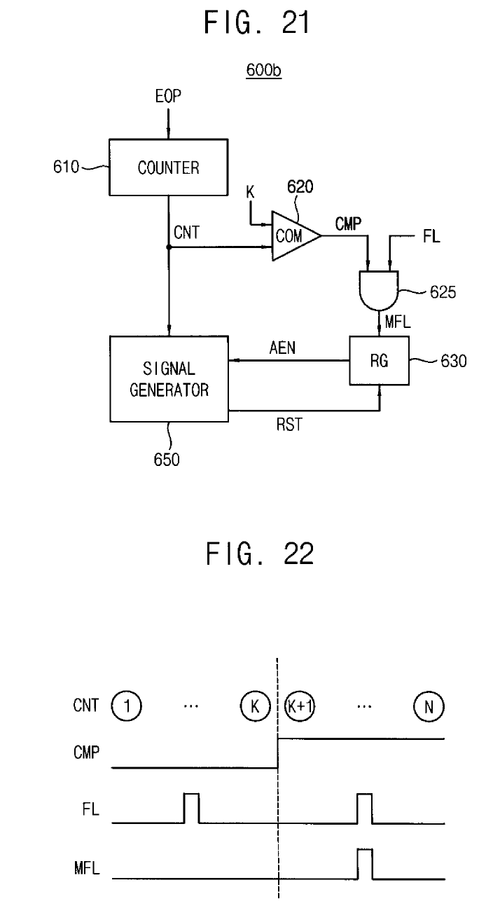

FIG. 21 is a block diagram illustrating an example of a picture type decision block in the video encoder of FIG. 2, and FIG. 22 is a diagram illustrating an operation of the picture type decision block of FIG. 21.

Referring to FIG. 21, a picture type decision block 600b may include a counter 610, a comparator 620, an AND logic gate 625, a register (FG) 630 and a signal generator 650. Compared with the picture type decision block 600a in FIG. 8, the picture type decision block 600b in FIG. 21 further includes the comparator 620 and the AND logic gate 625 and generates a mask flag signal MFL instead of the flag signal FL. A remaining configuration and operation are the same as described with reference to FIGS. 8 and 9, and a repeated description is thus omitted here.

Referring to FIGS. 21 and 22, the comparator 620 compares the reference value K and the count value CNT to generate a comparison signal CMP that is activated when the count value CNT is greater than the reference value K. The AND logic gate 625 performs an AND logic operation on the comparison signal CMP and the flag signal FL to generate the mask flag signal MFL. The mask flag signal MFL may maintain the deactivated level even though the flag signal FL is activated if the scene change occurs between the previous intra picture and the K-th picture. The mask signal MFL may be activated to set the register 630 to the value “1” only if the scene change occurs after the K-th picture. In this way, the cases of detecting the scene change may be divided into the first case CASE1 and the second case CASE2 as described with reference to FIG. 20. As a result, the signal generator 650 may set the GOP size to the normal size N in the first case CASE1 and increase the GOP size to be greater than the normal size N in the second case CASE2.

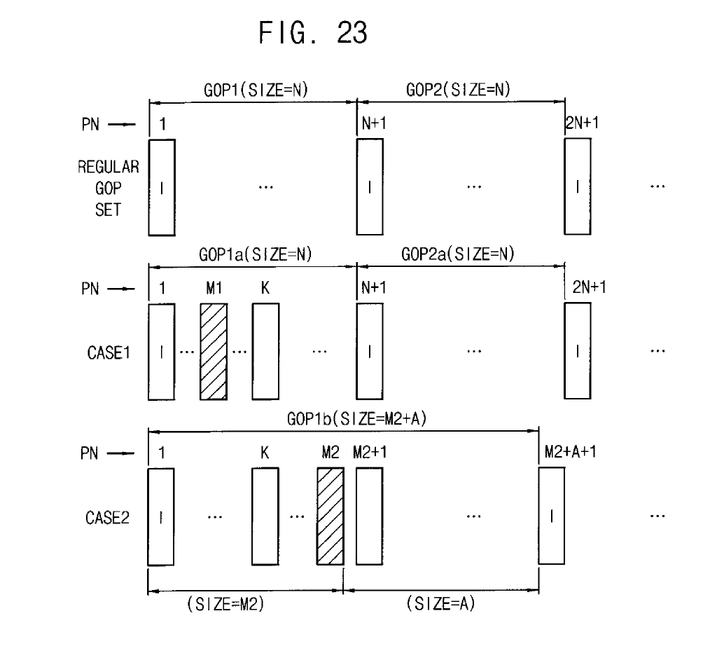

FIG. 23 is a diagram illustrating an example of GOPs that are adaptively set according to an example embodiment of the inventive concept.

The regular GOP set is illustrated in the upper portion of FIG. 23, and the adaptive GOP set when the scene change is detected is illustrated in the lower portion of FIG. 23.

As described with reference to FIG. 3, the size of the picture groups GOP1 and GOP2 may be set to the normal size N by assigning the I picture regularly when the scene change is not detected.

Referring to FIG. 23, cases of detecting the scene change may be divided into a first case CASE1 when the scene change is detected between the previous intra picture (1) and the K-th picture (K) and a second case CASE2 when the scene change is detected after the K-th picture (K). The reference value K may be properly set to be smaller than the normal size N considering the error propagation and the effect of the stream size reduction.

In the first case CASE1, the scene change occurs relatively near the previous intra picture (1) and thus the sufficient picture interval may be secured between the scene change picture (M1) and the picture (N+1) to be assigned as the intra picture according to the normal size N. In this case, the error propagation may be excessively increased if the GOP size is increased and thus the size of the picture groups GOP1a and GOP2a may be maintained as the normal size N.

In the second case CASE2, the scene change occurs relatively far from the previous intra picture (1) and thus the picture interval may be insufficient between the scene change picture (M2) and the picture (N+1) to be assigned as the intra picture according to the normal size N. In this case, the stream size may be unnecessarily increased if the normal size N is maintained. Accordingly the intra picture may be assigned to the picture (M2+A+1) after the scene change picture (M2) so that the number of pictures between the scene change picture (M2) and the next intra picture (M2+A+1) may correspond to the additional size A. In this case, the size of the picture group GOP1b including the scene change picture (M2) may be increased to a sum M2+A of the additional size A and the number M2 of pictures between the previous intra picture (1) and the picture (M2) lastly detected as the scene change. The additional size A may be determined to satisfy K+A>N so that the increased size M2+A may be greater than the normal size N.

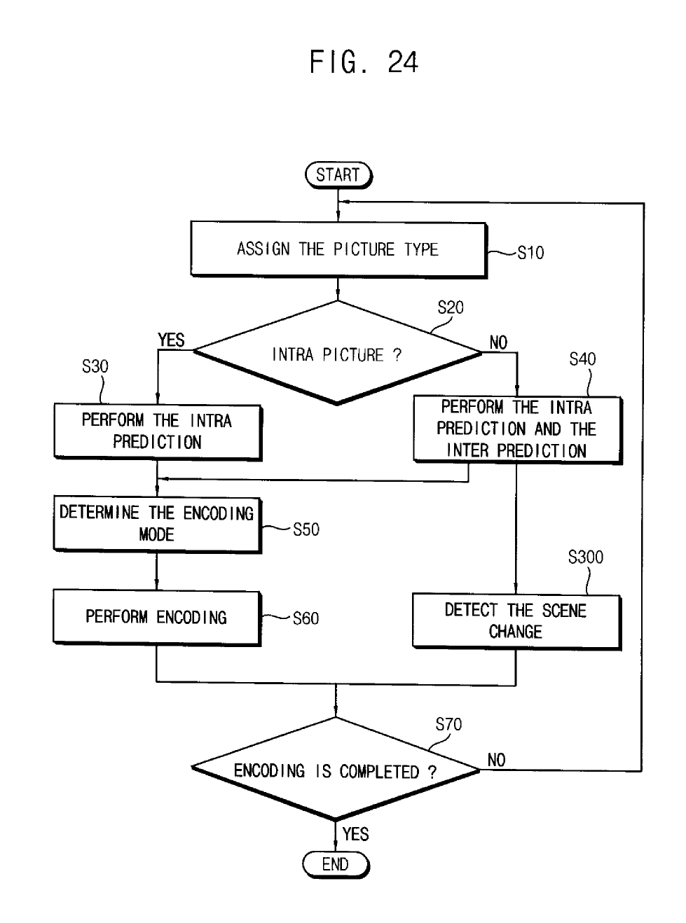

FIG. 24 is a flow chart illustrating a method of operating a video encoder according to example embodiments.

Referring to FIGS. 2 and 24, the picture type decision block 600 may determine the picture type of the currently-encoded picture (S10) among the I picture, the P picture and the B picture, using the picture type assigning signal PTA. As described above, the picture type decision block 600 may perform the adaptive GOP setting based on the detection result of the scene change. When the current picture is the intra picture (S20: YES), the encoding module 100 performs the intra-picture prediction (S30) in units of a macroblock, determines the encoding mode (S50) based on the result of the intra-picture prediction, and performs the encoding (S60) according to the determined encoding mode.

When the current picture is not the intra picture (S20: NO), that is, when the current picture is the inter picture, the encoding module 100 performs the intra-picture prediction and the inter-picture prediction (S40) in units of a macroblock, determines the encoding mode (S50) based on the result of the intra-picture prediction and the inter-picture prediction, and performs the encoding (S60) according to the determined encoding mode. When the current picture is the inter picture (S20: NO), the scene change detection block 700 may detect the scene change (S300) based on the result of the intra-picture prediction and the inter-picture prediction. The picture type is determined with respect to each picture, and the above processes S10, S20, S30, S40, S50, S60 and S300 may be repeated in units of a picture until encoding is completed (S70: YES) with respect to all the pictures.

As such, detecting the scene change may be omitted with respect to the intra picture and detecting the scene change may be performed with respect to the inter picture. Also the scene change detection may be performed through post-processing. In other words, the detection of the scene change may be performed using the prediction result that is required inevitably in the encoding process. Thus the scene change may be detected efficiently without the addition burden of software and/or hardware for the scene change detection through the pre-processing.

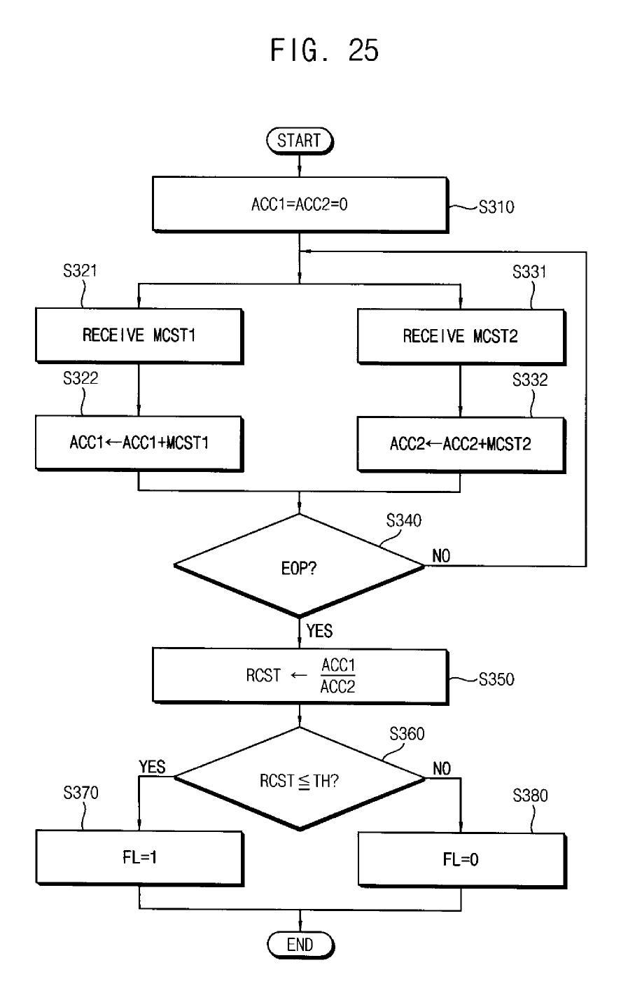

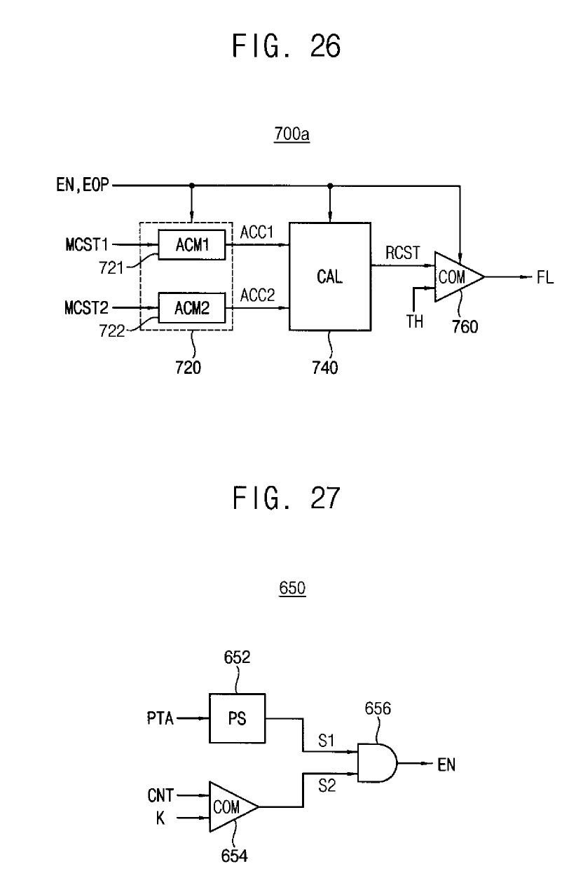

FIG. 25 is a flow chart illustrating a method of detecting a scene change according to example embodiments, and FIG. 26 is a block diagram illustrating an example of a scene change detection in the video encoder of FIG. 2.

Referring to FIGS. 25 and 26, the scene change detection block 700a may include an accumulator 720, a ratio calculator (CAL) 740 and a comparator (COM) 760. The accumulator 720 may include a first accumulator (ACM1) 721 and a second accumulator (ACM2) 722. The scene change detection block 700a may be enabled in response to an enable signal EN.

The scene change detection block 700a may be initialized in response to a picture end signal EOP (S310). For example, an intra accumulation value ACC1 and an inter accumulation value ACC2 may be set to “0”.

The first accumulator 721 may receive a least intra ratio-distortion cost MCST1 (S321) in units of a macroblock, and accumulate the sequentially input costs to provide the intra accumulation value ACC1 (S322). The second accumulator 722 may receive a least inter ratio-distortion cost MCST2 (S331) in units of a macroblock, and accumulate the sequentially input costs to provide the inter accumulation value ACC2 (S332). The least intra ratio-distortion cost MCST1 and the least inter ratio-distortion cost MCST2 may be provided from the prediction block 200 as described with reference to FIG. 2. Such accumulation may be repeated until the picture end signal EOP is activated (S340: NO), that is, until all of the macroblocks in the current picture are encoded.

When all of the macroblocks in the current picture are encoded (S340: YES), the ratio calculator 740 may calculate and provide a ratio RCST of the intra accumulation value ACC1 to the inter accumulation value ACC2 (S350).

The comparator 760 may compare the ratio RCST with a reference value TH to generate the flag signal FL. When the ratio RCST is equal to or smaller than the reference value TH (S360: YES), the comparator 760 may activate the flag signal (S370) to indicate that the scene change occurs. When the ratio RCST is greater than the reference value TH (S360: NO), the comparator 760 may deactivate the flag signal (S380) to indicate that the scene change does not occur. For example, the flag signal FL may be activated to the logic high level “1” and deactivated to the logic low level “0”.

FIG. 25 illustrates the scene change detection for the one picture. The same processes may be repeated to detect the scene change with respect to a plurality of pictures. As such, the scene change may be detected exactly by comparing the accumulation value of the least intra ratio-distortion costs and the least inter ratio-distortion costs.

FIG. 27 is a block diagram illustrating an example of an enable signal generator in the video encoder of FIG. 2.

Referring to FIG. 27, an enable signal generator 650 may include a picture type selector (PS) 652, a comparator (COM) 654 and an AND logic gate 656.

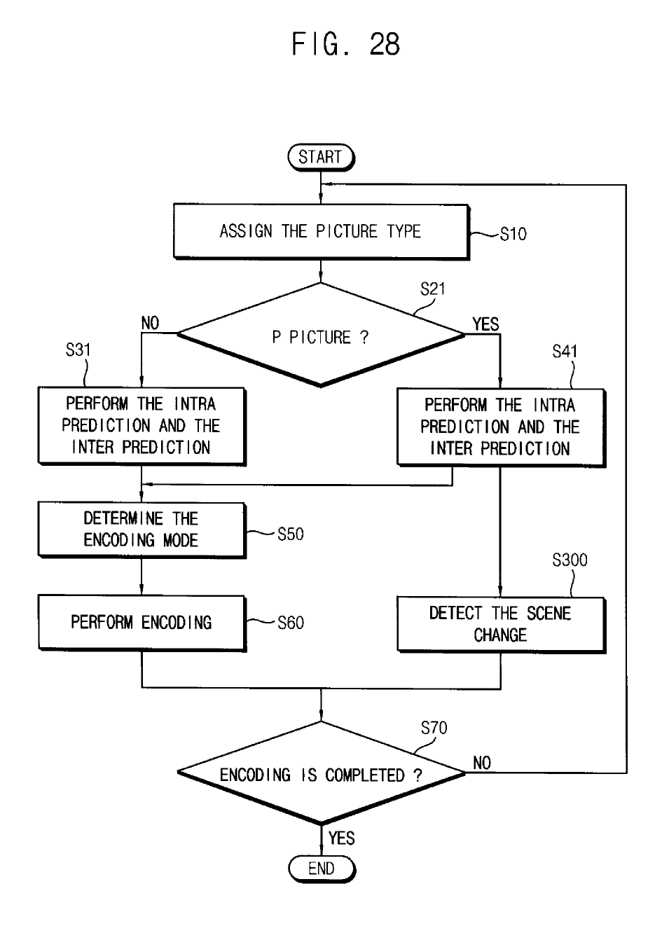

The picture type selector 652 may generate, based on the picture type assigning signal PTA, a first signal S1 that is activated when the current picture corresponds to a particular type. For example, in implementing the method of FIG. 24, the first signal S1 may be deactivated to the logic low level when the current picture is the intra picture and activated to the logic high level when the current picture is the inter picture. In implementing the method of FIG. 28 as described below, the first signal S1 may be deactivated to the logic low level when the current picture is the intra picture or the B picture and activated to the logic high level only when the current picture is the P picture.

The comparator 654 may operate similarly to the comparator 620 in FIG. 21 to generate a second signal S2 that is activated to the logic high level when the count value CNT is greater than the reference value K.

The AND logic gate 656 may perform a logic operation on the first signal S1 and the second signal S2 to generate the enable signal EN. The enable signal EN may be provided to the scene change detection block 700 and the scene change detection block 700 may be configured to perform the above-described scene change detection only when the enable signal EN is activated. The enable signal generator 650 may be included in the picture type decision block 600 or in the scene change detection block 700.

As such, the scene change detection may be performed with respect to the picture of the particular type in response to the selective activation of the first signal S1 from the picture type selector 652. For example, the scene change detection may be performed with respect to the inter picture including the P picture and the B picture, or only with respect to the P picture. In addition, the scene change detection may be omitted with respect to the pictures between the previous intra picture and the K-th picture from the previous intra picture where K is an integer smaller than the normal size and may be performed with respect to the pictures after the K-th picture, in response to the selective activation of the second signal S2 from the comparator 654. The similar function to the picture type decision block 600b in FIG. 21 may be implemented by combining the picture type decision block 600a in FIG. 8 and the enable signal generator 650 in FIG. 27.

FIG. 28 is a flow chart illustrating a method of operating a video encoder according to example embodiments.

Referring to FIGS. 2 and 28, the picture type decision block 600 may determine the picture type of the currently-encoded picture (S10) among the I picture, the P picture and the B picture, using the picture type assigning signal PTA. As described above, the picture type decision block 600 may perform the adaptive GOP setting based on the detection result of the scene change. When the current picture is not the P picture (S21: NO), the encoding module 100 performs the intra-picture prediction and the inter-picture prediction (S31) in units of a macroblock, determines the encoding mode (S50) based on the result of the intra-picture prediction and the inter-picture prediction, and performs the encoding (S60) according to the determined encoding mode.

When the current picture is the P picture (S21: YES), the encoding module 100 performs the intra-picture prediction and the inter-picture prediction (S41) in units of a macroblock, determines the encoding mode (S50) based on the result of the intra-picture prediction and the inter-picture prediction, and performs the encoding (S60) according to the determined encoding mode. When the current picture is the P picture (S21: YES), the scene change detection block 700 may detect the scene change (S300) based on the result of the intra-picture prediction and the inter-picture prediction. The picture type is determined with respect to each picture, and the above processes S10, S21, S31, S41, S50, S60 and S300 may be repeated in units of a picture until encoding is completed (S70: YES) with respect to all the pictures.

As such, detecting the scene change may be omitted with respect to the intra picture and the B picture, and detecting the scene change may be performed with respect to the P picture. Also the scene change detection may be performed through post-processing. In other words, the detection of the scene change may be performed using the prediction result that will inevitably be required in the encoding process. Thus, the scene change may be efficiently detected without the additional burden of software and/or hardware for the scene change detection through pre-processing.

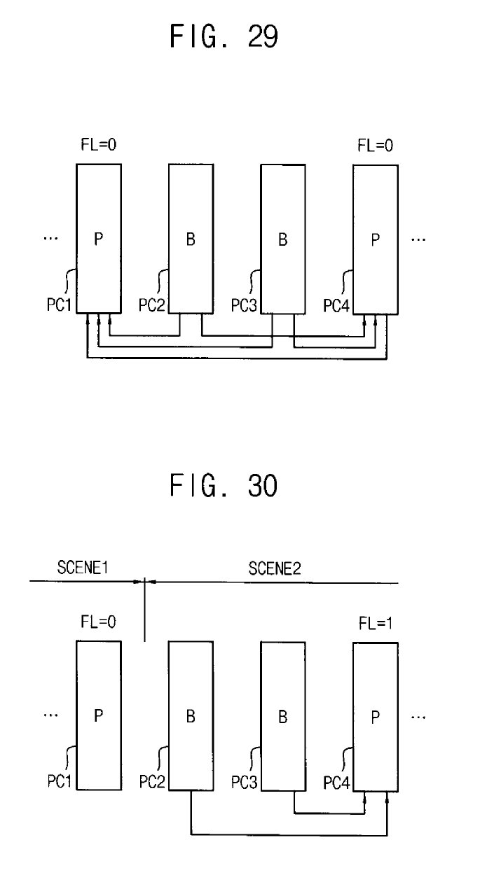

FIG. 29 is a diagram for reference in describing reference pictures depending on picture types, and FIGS. 30, 31 and 32 are diagrams for reference in describing relationships between detected scene changes and real scene changes.

A first picture PC1, a second picture PC2, a third picture PC3 and a fourth picture PC2 according to the display order are illustrated in FIGS. 29 through 31. The first and fourth pictures PC1 and PC4 are the P picture that is encoded with reference to the previous pictures and the second and third pictures PC2 and PC3 are the B pictures that is encoded with reference to the previous and next pictures.

FIG. 29 illustrates a case that the scene change is not detected with respect to the first though fourth pictures PC1 through PC4. As described above, the scene change detection may be performed only for the P picture. In this case, the flag signal FL is deactivated to the logic low level “0” with respect to the first and fourth pictures PC1 and PC4, and the four pictures PC1 through PC4 form the same scene.

The coding order may be different from the display order because the range of the reference pictures may be varied depending on the picture type. The first picture PC1 is encoded and then the fourth picture PC4 is encoded with reference to the reconstructed picture of the first picture PC1. The second and third pictures PC2 and PC3 are encoded with reference to the first picture PC1 corresponding to the previous picture and the fourth picture PC4 corresponding to the next picture. According to example embodiments, the B picture may be used as the reference picture and the P picture may be encoded with reference to a plurality of the reference pictures.

FIGS. 30, 31 and 32 illustrate respective examples in which the fourth picture PC 4 is detected as the scene change and thus the flag signal FL is activated to the logic high level “1”. The second picture PC2 and the third picture PC3 precede the fourth picture PC4 in the display order but lag behind the fourth picture PC4 in the coding order.

FIG. 30 illustrates the case that the first picture PC1 is included in the first scene SCENE1, and the second, third and fourth pictures PC2, PC3 and PC4 are included in the second scene SCENE2. In this case, the second and third pictures PC2 and PC3 have the higher correlation to the fourth picture PC4 than to the first picture PC1, and thus most of the macroblocks in the second and third pictures PC2 and PC3 may be encoded with reference to the fourth picture PC4.

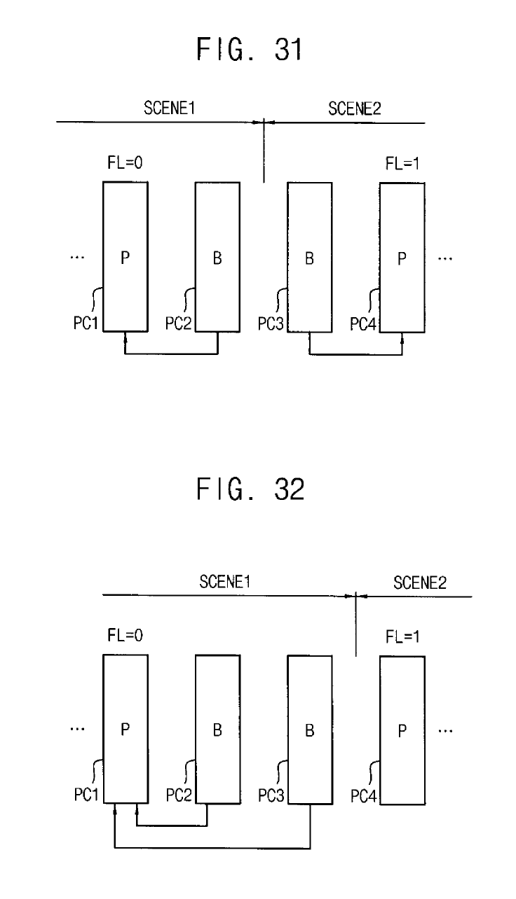

FIG. 31 illustrates the case that the first and second pictures PC1 and PC2 are included in the first scene SCENE1, and the third and fourth pictures PC3 and PC4 are included in the second scene SCENE2. In this case, according to the correlation to the reference pictures, most of the macroblocks in the second picture PC2 may be encoded with reference to the first picture PC1, and most of the macroblocks in the third picture PC3 may be encoded with reference to the fourth picture PC4.

FIG. 32 illustrates the case that the first, second and third pictures PC1, PC2 and PC3 are included in the first scene SCENE1, and the fourth picture PC4 is included in the second scene SCENE2. In this case, according to the correlation to the reference picture, most of the macroblocks in the second and third pictures PC2 and PC3 may be encoded with reference to the first picture PC1.

As such, efficient encoding for reducing the stream size may be implemented by performing the scene change detection only for the P picture, even though the real scene change occurs in the B picture.

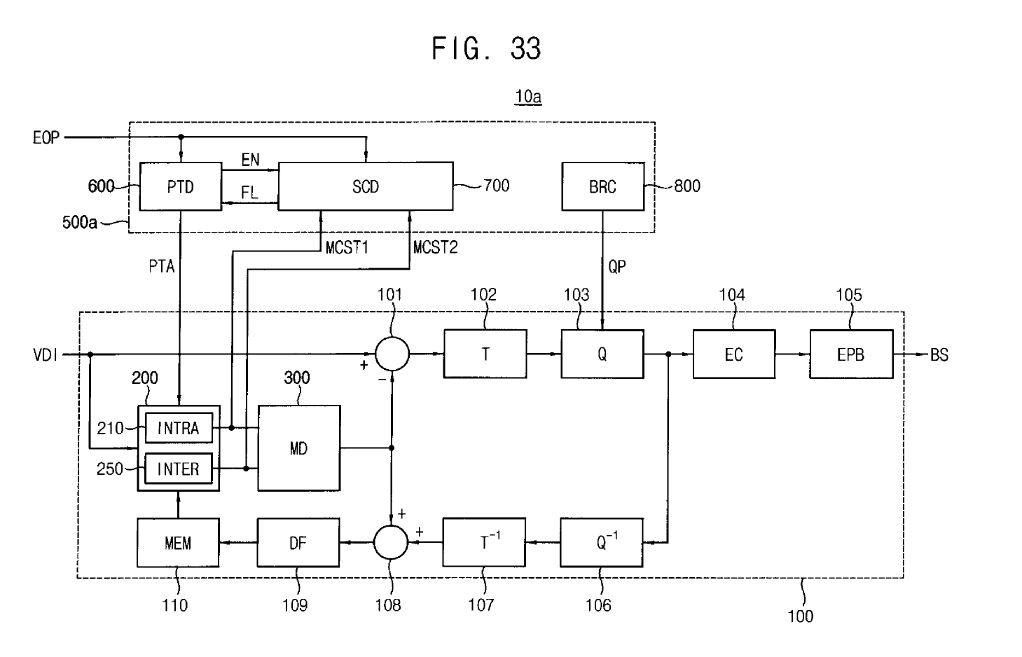

FIG. 33 is a block diagram illustrating a video encoder according to example embodiments of the inventive concept.

Referring to FIG. 33, a video encoder 10a includes an encoding module 100 and a control module 500a.

The encoding module 100 receives input video data signal VDI that provides data bits in units of a macroblock. The encoding module 100 determines an encoding mode of each macroblock by performing an intra-picture prediction and an inter-picture prediction, and encodes the video data in units of a macroblock according to the determined encoding mode. The configuration and operation of the encoding module 100 are the same as described with reference to FIG. 2 and the repeated descriptions are omitted.

The control module 500a detects the scene change in units of a picture based on the result of the intra-picture prediction and the inter-picture prediction, that is, the least intra rate-distortion cost MCST1 and the least inter rate-distortion cost MCST2 from the encoding module 100 and adjusts the size of the GOP based on the detection result of the scene change.

The control module 500a may include a picture type decision block (PTD) 600, a scene change detection block (SCD) 700 and a bit rate control block (BRC) 800.

The scene change detection block 700 may generate a flag signal FL indicating whether the scene change is detected based on the least intra rate-distortion cost MCST1 and the least inter rate-distortion cost MCST2 from the encoding module 100. For example, as described with reference to FIGS. 24 through 32, the scene change detection block 700 may calculate an intra accumulation value ACC1 and an inter accumulation value ACC2 by summing the least intra ratio-distortion costs MCST1s and the least inter ratio-distortion costs MCST2s in units of a picture to generate the flag signal FL based on the intra accumulation value ACC1 and the inter accumulation value ACC2. The scene change detection block 700 may determine the logic level of the flag signal FL in synchronization with a picture end signal EOP that is activated whenever encoding of each picture is completed.

The picture type decision block 600 may adjust the size of the GOP based on the flag signal FL. The picture type decision block 600 may generate the picture type assigning signal PTA that is varied in synchronization with the picture end signal EOP to indicate the picture type of the currently-encoded picture. For example, the picture type assigning signal PTA may indicate the I picture, the P picture or the B picture. The size of the GOP may be determined by the assigning interval of the I pictures that are encoded without reference to other pictures. The structure of the GOP may be determined by the assigning pattern of the P pictures that are encoded with reference to the previous pictures, and the B pictures that are encoded with reference to the next pictures. The picture type decision block 600 may generate an enable signal EN for selectively enabling the scene change detection block 700 depending on the picture type of the currently-encoded picture.

Compared with the control module 500 in FIG. 2, the control module 500a in FIG. 33 further includes the bit rate control block 800. The bit rate control block 800 may control a bit rate of the encoded data based on the result of the intra-picture prediction and the inter-picture prediction for determining the encoding mode of each macroblock.

In an example embodiment, the bit rate control block 800 may adjust a quantization parameter QP in units of a macroblock based on the least intra rate-distortion cost MCST1 and the least inter rate-distortion cost MCST2 of each macroblock. In another example embodiment, the bit rate control block 800 may adjust the quantization parameter QP in units of a picture based on the intra accumulation value ACC1 and the inter accumulation value ACC2 that are calculated by summing the least intra rate-distortion costs and least inter rate-distortion costs of a plurality of macroblocks in each picture. In still another example embodiment, the bit rate control block 800 may both perform the bit rate control in units of a macroblock and the bit rate control in units of a picture.

The video encoder may fix the size and structure of the GOP and the bit rate control may be performed based on the fixed GOP. In general, the schemes for efficiently managing the stream size may be referred to as a rate control (RC). A budget for the rate control is allocated to each picture group and a target bit number is allocated to each picture and/or each macroblock within the allocated budget. The target bit number may be represented by the quantum parameter QP, and the bit number of the encoded data is decreased as the quantum parameter QP is increased. In other words, the image quality is degraded as the quantum parameter QP is increased.

By adopting the adaptive bit control based on the detection result of the scene change in addition to the adaptive GOP setting, the image quality may be stabilized and the stream size may be reduced.

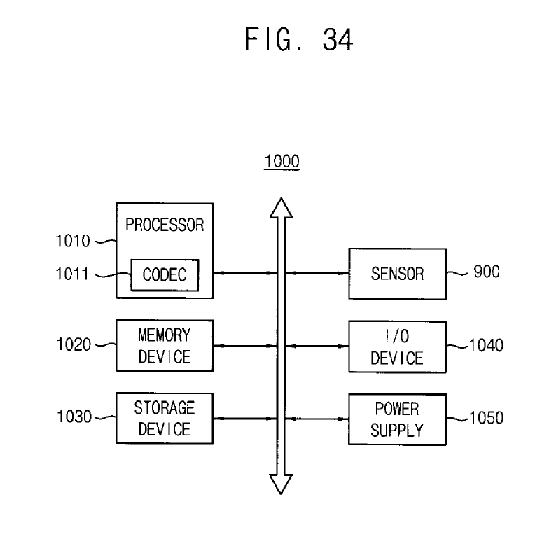

FIG. 34 illustrates a block diagram of a computer system including a video encoder according to example embodiments of the inventive concept.

Referring to FIG. 34, a computing system 1000 may include a processor 1010, a memory device 1020, a storage device 1030, an input/output device 1040, a power supply 1050, and an image sensor 900. Although it is not illustrated in FIG. 34, the computing system 1000 may further include ports that communicate with a video card, a sound card, a memory card, a universal serial bus (USB) device, and/or other electronic devices.

The processor 1010 may perform multiple different calculations or tasks. The processor 1010 may include a video coder/decoder (codec) 1011. The codec 1011 may include the video encoder according to example embodiments as described with reference to FIGS. 1 through 33. In addition, the codec may include a video decoder for decoding the compressed data that are encoded by the video encoder. In an example embodiment, the video encoder and the video decoder may be merged in the same integration circuit and/or corresponding software. According to some embodiments, the processor 1010 may be a microprocessor or a central processing unit (CPU). The processor 1010 may communicate with the memory device 1020, the storage device 1030, and the input/output device 1040 via an address bus, a control bus, and/or a data bus. In some example embodiments, the processor 1010 may be coupled to an extended bus, such as a peripheral component interconnection (PCI) bus. The memory device 1020 may store data for operating the computing system 1000. For example, the memory device 1020 may be implemented using a dynamic random access memory (DRAM) device, a mobile DRAM device, a static random access memory (SRAM) device, a phase random access memory (PRAM) device, a ferroelectric random access memory (FRAM) device, a resistive random access memory (RRAM) device, and/or a magnetic random access memory (MRAM) device. The storage device may include a solid state drive (SSD), a hard disk drive (HDD), a compact-disc read-only memory (CD-ROM), etc. The input/output device 1040 may include an input device (e.g., a keyboard, a keypad, a mouse, etc.) and an output device (e.g., a printer, a display device, etc.). The power supply 1050 supplies operation voltages for the computing system 1000.

The image sensor 900 may communicate with the processor 1010 via the buses or other communication links. The image sensor 900 may be integrated with the processor 1010 in one chip, or the image sensor 900 and the processor 1010 may be implemented as separate chips.

The computing system 1000 may be packaged according to any one or more of a large variety of packaging technologies, such as package on package (PoP), ball grid arrays (BGAs), chip scale packages (CSPs), plastic leaded chip carrier (PLCC), plastic dual in-line package (PDIP), die in waffle pack, die in wafer form, chip on board (COB), ceramic dual in-line package (CERDIP), plastic metric quad flat pack (MQFP), thin quad flat pack (TQFP), small outline integrated circuit (SOIC), shrink small outline package (SSOP), thin small outline package (TSOP), system in package (SIP), multi-chip package (MCP), wafer-level fabricated package (WFP), or wafer-level processed stack package (WSP).

The computing system 1000 may be any of a variety of computing systems using a three-dimensional image sensor. For example, the computing system 1000 may include a digital camera, a mobile phone, a smart phone, a portable multimedia player (PMP), a personal digital assistant (PDA), etc.

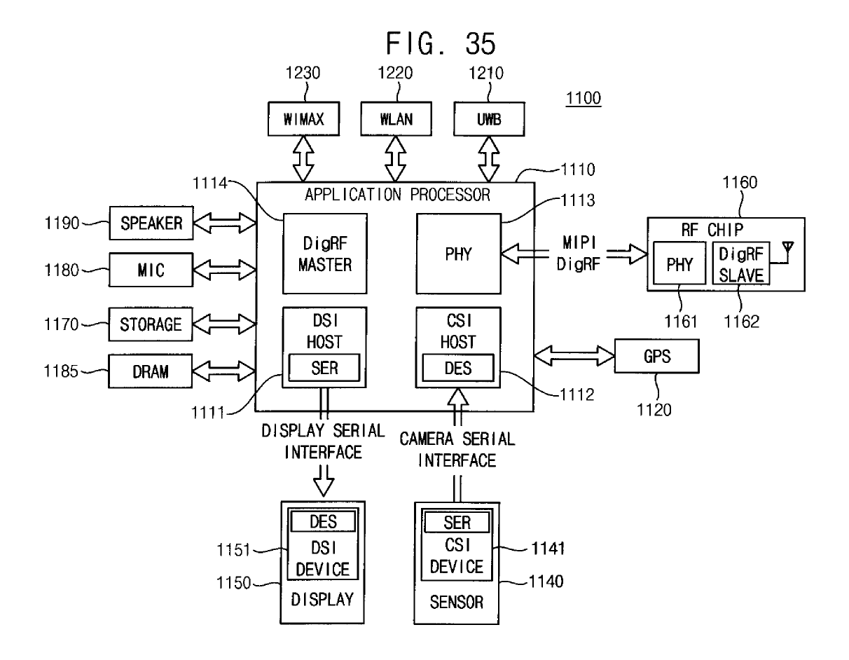

FIG. 35 illustrates a block diagram of an interface employable in the computing system of FIG. 34 according to example embodiments of the inventive concept.

Referring to FIG. 35, a computing system 1100 may be implemented by a data processing device that uses or supports a mobile industry processor interface (MIPI®) interface. The computing system 1100 may include an application processor 1110, a three-dimensional image sensor 1140, a display device 1150, etc. A CSI host 1112 of the application processor 1110 may perform serial communication with a CSI device 1141 of the three-dimensional image sensor 1140 via a camera serial interface (CSI). In some example embodiments, the CSI host 1112 may include a deserializer (DES), and the CSI device 1141 may include a serializer (SER). A DSI host 1111 of the application processor 1110 may perform serial communication with a DSI device 1151 of the display device 1150 via a display serial interface (DSI).

In some example embodiments, the DSI host 1111 may include a serializer (SER), and the DSI device 1151 may include a deserializer (DES). The computing system 1100 may further include a radio frequency (RF) chip 1160 perform communication with the application processor 1110. A physical layer (PHY) 1113 of the computing system 1100 and a physical layer (PHY) 1161 of the RF chip 1160 may perform data communications based on a MIPI® DigRFSM. The application processor 1110 may further include a DigRFSM MASTER 1114 that controls the data communications of the PHY 1161.

The computing system 1100 may further include a global positioning system (GPS) 1120, a storage 1170, a MIC 1180, a DRAM device 1185, and a speaker 1190. In addition, the computing system 1100 may perform communication using an ultra-wideband (UWB) 1210, a wireless local area network (WLAN) 1220, a worldwide interoperability for microwave access (WIMAX) 1230, etc. However, the structure and the interface of the computing system 1100 are not limited thereto.

As will be appreciated by those skilled in the art, the present inventive concept may be embodied as a system, method, computer program product, and/or a computer program product embodied in one or more computer readable medium(s) having computer readable program code embodied thereon. The computer readable program code may be provided to a processor of a general purpose computer, special purpose computer, or other programmable data processing apparatus. The computer readable medium may be a computer readable signal medium or a computer readable storage medium. The computer readable storage medium may be any tangible medium that can contain, or store a program for use by or in connection with an instruction execution system, apparatus, or device.

Some example embodiments of the inventive concept may be applied to various devices and/or systems that encode video data based on a GOP. Particularly, some example embodiments of the inventive concept may be applied to a video encoder that is compatible with standards such MPEG, H.261, H.262, H.263 and H.264. Some example embodiments of the inventive concept may be adopted in technical fields such as CATV (Cable TV on optical networks, copper, etc.), DBS (Direct broadcast satellite video services), DSL(Digital subscriber line video services), DTTB(Digital terrestrial television broadcasting), ISM (Interactive storage media (optical disks, etc.)), MMM (Multimedia mailing), MSPN (Multimedia services over packet networks), RTC (Real-time conversational services (videoconferencing, videophone, etc.)), RVS (Remote video surveillance), SSM (Serial storage media (digital VTR, etc.))

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A method of controlling a video encoder, the video encoder configured to encode video data in units of macroblocks based on a group of pictures (GOP), the GOP being determined by assigning intra pictures and inter pictures, each intra picture being encoded without reference to other pictures, each inter picture being encoded with reference to other pictures, the method comprising:
determining an encoding mode of each macroblock by performing an intra-picture prediction and an inter-picture prediction;
detecting whether each unit of a picture is a scene change based on a result of the intra-picture prediction and the inter-picture prediction for determining the encoding mode of each macroblock; and
adaptively setting a size of the GOP based on a result of detecting whether each unit of a picture is the scene change.

2. The method of claim 1, wherein adaptively setting the size of the GOP includes:
when the scene change is not detected, setting the size of the GOP to a normal size by regularly assigning the intra picture; and
when a first picture is detected as the scene change, setting the size of the GOP including the first picture to an increased size which is greater than the normal size.

3. The method of claim 2, wherein setting the size of the GOP to the increased size includes:
assigning the inter picture to a second picture after the first picture where the second picture is to be assigned as the intra picture according to the normal size when the scene change is not detected.

4. The method of claim 3, wherein setting the size of the GOP to the increased size further includes:
when a third picture is detected as the scene change again after assigning the inter picture to the second picture, assigning the inter picture to a fourth picture after the third picture where the fourth picture is to be assigned as the intra picture according to the normal size when the scene change is not detected.

5. The method of claim 4, wherein a P picture is assigned to the second picture and the fourth picture, where the P picture is encoded with reference to at least one of previous pictures.

6. The method of claim 2, wherein the increased sized is K times the normal size, where K is an integer greater than two.

7. The method of claim 2, wherein setting the size of the GOP to the increased size includes:
assigning the intra picture to a second picture after the first picture where a number of pictures between the first and second pictures corresponds to an additional size.

8. The method of claim 7, wherein setting the size of the GOP to the increased size further includes:
when a third picture is detected as the scene change again before assigning the intra picture to the second picture, assigning the intra picture to a fourth picture after the third picture where a number of pictures between the third and fourth pictures corresponds to the additional size.

9. The method of claim 8, wherein the size of the GOP including at least one picture detected as the scene change is set to a sum of the additional size and a number of pictures between the previous intra picture and the picture lastly detected as the scene change.

10. The method of claim 9, wherein the additional size is set to be equal to the normal size.

11. The method of claim 1, wherein adaptively setting the size of the GOP includes:
when the scene change is not detected, setting the size of the GOP to a normal size by regularly assigning the intra picture;
when a first picture is detected as the scene change and the first picture is between a previous intra picture and a K-th picture from the previous intra picture, where K is a positive integer smaller than the normal size, setting the size of the GOP including the first picture to the normal size; and
when the first picture is after the K-th picture, setting the size of the GOP including the first picture to an increased size which is greater than the normal size.

12. The method of claim 1, wherein determining the encoding mode of each macroblock includes:
calculating a least intra rate-distortion cost by the intra-picture prediction and a least inter rate-distortion cost by the inter-picture prediction, with respect to each macroblock; and
determining the encoding mode as a mode corresponding to a smaller value among the least intra rate-distortion cost and the least inter rate-distortion cost.

13. The method of claim 12, wherein detecting whether each unit of a picture is a scene change includes:
with respect to a plurality of macroblocks in each picture, calculating an intra accumulation value and an inter accumulation value by summing the least intra rate-distortion costs and by summing the least inter rate-distortion costs; and
determining whether the scene change is detected with respect to each picture based on the intra accumulation value and the inter accumulation value.

14. The method of claim 13, wherein determining whether the scene change is detected includes:
calculating a ratio of the intra accumulation value to the inter accumulation value;
determining that the scene change is detected when the ratio is equal to or smaller than a reference value; and
determining that the scene change is not detected when the ratio is greater than the reference value.

15. The method of claim 13, wherein detecting whether each unit of a picture is a scene change further includes:
generating a flag signal indicating whether the scene change is detected.

16. The method of claim 1, wherein detecting the scene change is omitted with respect to each intra picture and detecting the scene change is performed with respect to each inter picture.

17. The method of claim 1, wherein detecting the scene change is omitted with respect to each intra picture and each of B pictures, and detecting the scene change is performed with respect to each of P pictures, where each P picture is encoded with reference to at least one of previous pictures and each B picture is encoded with reference to at least one of previous pictures and at least one of next pictures.

18. The method of claim 1, wherein detecting the scene change is omitted with respect to pictures prior a K-th picture from a previous intra picture, where K is a positive integer smaller than the normal size, and detecting the scene change is performed with respect to the pictures after the K-th picture.

19. The method of claim 1, further comprising:
controlling a bit rate of encoded data based on the result of the intra-picture prediction and the inter-picture prediction for determining the encoding mode of each macroblock.

20. The method of claim 19, wherein controlling the bit rate of the encoded data includes:
adjusting a quantization parameter in units of a macroblock based on a least intra rate-distortion cost and a least inter rate-distortion cost of each macroblock.

21. The method of claim 19, wherein controlling the bit rate of the encoded data includes:
adjusting a quantization parameter in units of a picture based on an intra accumulation value and an inter accumulation value that are calculated by summing least intra rate-distortion costs and least inter rate-distortion costs of a plurality of macroblocks in each picture.

22. The method of claim 1, wherein the video encoder is compatible with an H.264 standard.

23. A video encoder for encoding video data in units of a macroblock based on a group of pictures (GOP), the GOP being determined by assigning intra pictures and inter pictures, each intra picture being encoded without reference to other pictures, each inter picture being encoded with reference to other pictures, the video encoder comprising:
an encoding module configured to determine an encoding mode of each macroblock by performing an intra-picture prediction and an inter-picture prediction, wherein the video data is encoded by units of macroblocks according to the determined encoding mode; and
a control module configured to detect a scene change in units of a picture based on a result of the intra-picture prediction and the inter-picture prediction for determining the encoding mode of each macroblock, and configured to adaptively set a size of the GOP based on a detection result of the scene change.

24. The video encoder of claim 23, wherein the control module includes:
a scene change detection block configured to generate a flag signal indicating whether the scene change is detected based on an intra accumulation value and an inter accumulation value where the intra accumulation value and the inter accumulation value are calculated by summing least intra ratio-distortion costs and least inter ratio-distortion costs in units of a picture, and the least intra ratio-distortion costs and least inter ratio-distortion costs are provided from the encoding module in units of a macroblock; and
a picture type decision block configured to set the size of the GOP based on the flag signal.

25. The video encoder of claim 24, further comprising a bit rate control block configured to control a bit rate of encoded data based on the result of the intra-picture prediction and the inter-picture prediction for determining the encoding mode of each macroblock.

26. The video encoder of claim 25, wherein the bit rate control block is configured to adjust a quantization parameter in units of a macroblock based on a least intra rate-distortion cost and a least inter rate-distortion cost of each macroblock.

27. The method of claim 15, wherein the bit rate control block is configured to adjust a quantization parameter in units of a picture based on an intra accumulation value and an inter accumulation value that are calculated by summing least intra rate-distortion costs and least inter rate-distortion costs of a plurality of macroblocks in each picture.

28. A computing system comprising a processor and an image sensor, the processor including the video encoder of claim 23.

29. The computing system of claim 28, wherein the video encoder is compatible with an H.264 standard.

30. A method of detecting a scene change in video data, the method comprising:
receiving video data;
calculating a least intra rate-distortion cost by an intra-picture prediction and a least inter rate-distortion cost by an inter-picture prediction, with respect to each macroblock of the video data;
with respect to a plurality of macroblocks in each picture of the video data, calculating an intra accumulation value and an inter accumulation value by summing the least intra rate-distortion costs and by summing the least inter rate-distortion costs; and
determining whether the scene change is detected with respect to each picture based on the intra accumulation value and the inter accumulation value.
